(19) United States
(12) Patent Application Publication
(10) Pub. No.: US 2006/0160596 A1
(43) Pub. Date: Jul. 20, 2006

(54) Gaming machine

(75) Inventors: Yasuyuki Sato, Tokyo (JP); Hirobumi Toyoda, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/288,247

(22) Filed: Nov. 29, 2005

(30) Foreign Application Priority Data
Nov. 30, 2004 (JP) P2004-347512
Nov. 30, 2004 (JP) P2004-347515
Nov. 30, 2004 (JP) P2004-347513
Nov. 30, 2004 (JP) P2004-347514

(51) Int. Cl. A63F 13/00

(52) U.S. Cl. 463/16; 463/20

(57) ABSTRACT

One embodiment of the present invention is a gaming machine having a credit-value/bet-value processor storing the number of bets paid out by a player, a stage information generator determining CPU-side dice-numbers for the gaming machine, a player-side dice determination device determining player-side dice-numbers for the player, and a stage win and loss determination device making comparison between the CPU-side dice-numbers and the player-side dice-numbers for determining a win and loss of the relevant stage, whereby from among a plurality of stages, a stage available for the player to play is determined depending on the number of bets stored in the credit/value processor.

### CROSS REFERENCE TO RELATED APPLICATIONS

This application is based upon and claims the benefit of priority from the prior Japanese Patent Applications No. 2004-347512, filed on Nov. 30, 2004, No. 2004-347515, filed on Nov. 30, 2004, No. 2004-347513, filed on Nov. 30, 2004 and No. 2004-347514, filed on Nov. 30, 2004, the entire contents of which are incorporated herein by reference.

### BACKGROUND OF THE INVENTION

1. Field of the Invention

The present invention relates to gaming machines and, more particularly, to a gaming machine by which a game is practiced utilizing gang tools, such as dices, which are well known in the art.

2. Description of the Related Art

Along with the popularization of home-use gaming machines (video games) and professional-use gaming machines in recent years, a variety of new games have heretofore been developed into practice to be provided to consumers. Upon diversification of marketed games, polarization makes the progress in so-called sellable games, a game that wins a big market, and an unsellable game. Under such a background, it becomes increasingly important for game developers to provide games acceptable for consumers to buy from among enormous numbers of new games released one after the other.

Meanwhile, one of conditions for a game to be selected by consumers resides in a fact that the game has a simple content that is easy for the player to adapt himself soon. Further, since a so-called heavy user has a tendency enjoying a complicated content, whereas a so-called light user does not has such tendency, it is difficult to make a game that can acceptable both heavy users and light users.

The game with the simple content configured to execute with the gaming tools to which many consumers are familiar (as disclosed in, for instance, Japanese Patent Application Laid Open Publication No. 2004-243010) have been known. If the games utilize play equipment and tools, such as playing cards and dices, which everybody have had experiences of use, many players become easy to understand the games and adapt themselves to the game soon.

However, even if the content of the game is simple, an issue arises with the player getting bored with the game unless it has strategic characteristics.

Therefore, it is a first object of the present invention to provide a game that is simple in content and has strategic characteristics.

Further, in order for games to be played by more players, the games should preferably satisfy both of light users, who are hard to clear the games each set in an excessively high difficulty level, and heavy users who feel no satisfaction on the games each set in a less difficulty level that can be easily cleared.

To satisfy both the light users and heavy users, proposal have heretofore been made to provide a gaming machine with a structure arranged such that among games of the related art, those of the games, involving course (in a difficulty level) selective screens, are provided to a player at a start of a game so as to allow the player to freely select an introductory course with a less difficulty level and an advanced level with a high difficulty level (as disclosed in, for instance, Japanese Patent Application Laid Open Publication No. 2000-107451 on paragraph [0033]. With the gaming machine enabling the player to select the courses with different difficulty levels in such a way, the player is able to enjoy the game with a difficulty level that suits own skills and tastes of the player.

Furthermore, another proposal has heretofore been undertaken to provide a gaming machine, providing a game with a difficulty level favored by the player, which enables the player to play a game upon switching over difficulty levels during a play of the game (as disclosed in, for instance, Japanese Patent Application Laid Open Publication No. 2002-018121 on paragraph [0013]).

However, with the game configured in a structure wherein even in a method for preliminarily preparing a plurality of courses with different difficulty levels to allow the player to select either one of the courses to cause the ditty level of the game to be adapted to the skills and tastes of the player, each course includes plural stages, areas and rounds or the like (hereinafter totally referred to as stages), the game has a structure to permit the player to clear the stages in such a way wherein a difficulty level increases with a progress in subsequent stages. Such a structure causes the player to have no feeling of the element of surprise with the resultant issues with a tendency for the player to have the feeling of the game with such a structure in a monotone.

Therefore, it is a second object of the present invention to provide a gaming machine that makes it possible to allow a player to set a difficulty level on a game while enabling a difficulty level to be set for each stage in a random manner so as to preclude the difficulty level from increasing with a progress on the stage in a monotone.

Moreover, it is a third object of the present invention to provide a gaming machine that is able to provide a player with a notification of a difficulty level for each stage for thereby providing the player with an ability of strategically selecting whether to challenge a subsequent stage or to finish the game on the current stage.

Another method for altering development of a game includes a process wherein a plurality of courses with mutually different difficulty levels are prepared whereby as a player executes a startup operation, a display device is provided with course selective screens and difficulty selective screens which can be selected by the player for choosing an introductory course with a low difficulty level and an advanced course with a high difficulty level to be executed (disclosed in, for instance, Japanese Laid Open Patent Publication No. 2000-107449 (on paragraph [0040]) and Japanese Laid Open Patent Publication No. 2000-107451 (on paragraph [0040]). Further, another method for altering development of a game includes a process wherein when a predetermined condition is established, a part of the number of credited coins is accumulated as a “Jackpot (bonus)”, when a player wins a lottery for the Jackpot, the number of the credited coins accumulated as the Jackpot is paid out to the player (disclosed in, for instance, Japanese Patent Application Laid Open Publication No. 10-118247 (on paragraph [0003])). Also, the “Jackpot” bonus represents a “premium” to be paid out separately of the payout to be made on the winning of a normal game.

As predetermined conditions under which such a “Jackpot” bonus is paid out, it has been common to deal such that the player credits the maximum number of coins allowable to be bet on one game.

However, with an attempt in which a chance of winning a “Jackpot” bonus only when a bet is made with the maximum number of coins, a player encounters a difficulty in selecting the number of bets in a strategic manner. That is, when targeting the acquisition of the Jackpot, it becomes hard to adjust the number of bets and a need arises for betting the number of coins with the max bet at all times. Therefore, when targeting the Jackpot, it has heretofore been difficult to take strategies of adjusting the number of bets in a normal game and adjusting the number of bets by decreasing the number of bets and taking a pass on a current game.

Therefore, it is a third object of the present invention to provide a gaming machine that enables control such that a number of bets, needed for the occurrence of winning a Jackpot, is defined in a width that can be set and altered.

Further, with a system employing a Jackpot disclosed in Japanese Laid Patent Application Laid Open Publication No. 10-1147 (on paragraph [0003]), a mere attempt to allow a player to select a course has resulted in a fear of the occurrence of inequality on a premium to be given when the game was won, that is, a payout of coins to be made between a player who selects an introductory course and another player who selects an advanced course. For instance, if the player receives the payout of the same number of coins in any course being selected, the selection of a low risk and high return is performed, resulting in tendencies for the player to acquire a premium in a more reliable manner upon selecting the introductory course at all times.

Therefore, it is a fourth object of the present invention to provide a gaming machine that is able to vary a difficulty level of a game depending on a number of bets.

### SUMMARY OF THE INVENTION

To achieve the first object, a gaming machine of the present invention is proposed as a gaming machine that is operative to allow a player to play a game including at least one stage in which a win and loss is determined upon comparison between a dice-number of the gaming machine side and a dice-number of the player side.

According to an aspect of the present invention, there is provided a gaming machine comprising: a first numeric value selection device selecting at least one first numeric value, in a predetermined range, for a player of the gaming machine, and having a first storage device storing the first numeric value; a second numeric value selection device selecting at least one second numeric value falling in the same range as that of the first numeric value and having a second storage device storing the second numeric value; and a win and loss determination device making comparison between the first numeric value and the second numeric value for determining a win and loss of a game to be executed by the gaming machine.

With the gaming machine of the presently filed embodiment, a game can be provided which is simple and provides a player with an obsession for a play.

Further, a player-side re-determination device is provided for re-determining a whole of or a part of the first numeric value, which are automatically determined by the first numeric value selection device.

With such a gaming machine, a need arises for a player to take strategic consideration on which of the dice-number is to be altered for the purpose of acquiring both of a win on a stage and a predetermined combination and on which of the dice-number is to be left, providing a capability of providing a game that is simple while having a strategic characteristic.

With the gaming machine set forth above, the win and loss determination device makes determination whether or not the first numeric value, selected by the first numeric value selection device, matches a predetermined combination whereby when the first numeric value matches the predetermined combination, a premium is paid out to the player.

With such a gaming machine, it becomes possible to provide a game that is possible to initiate a player's entertaining and exciting value as to whether or not a predetermined combination is established and is simple yet capable to attract the player's interest.

To achieve the second object set forth above, the ping machine of the present invention features to allow a player to play a game with a plurality of stages wherein comparison is made between at least one dice-number of the gaming machine side and at least one dice-number of the player side for determining a win and loss.

With such a gaming machine, the game, to be executed by the gaming machine, includes a plurality of stages. The gaming machine further comprises: a third value selection device operative to determine a third value based on which a value of a difficulty level is randomly determined for determining a difficulty level of each stage and at least one of the ranges, which the first and second numeric value selection devices can take, is determined depending on the value of the difficulty level; wherein the first numeric value selection device allows the first numeric value, selected by the first numeric value selection device, to be stored in the first storage device associated with a number corresponding to the third value determined by the third value selection device; wherein the second storage device allows the second numeric value, selected by the second numeric value selection device, to be stored in the second storage device associated with a number corresponding to the third value determined by the third value selection device; and wherein the win and loss determination device is operative to determine a win and loss for each stage.

With such a gaming machine, a stage (which may include either a whole stage or a partial stage) in a play of a game has difficulty levels that can be altered. The difficulty levels of the stage are set upon altering at least one of the third value selected for the second numeric value selection device and the third value set for the first numeric value selection device. With the gaming machine, it stands that the greater the number of dices on the gaming machine and less the number of dices on the player, the higher will be the difficulty level (with a decrease in a probability for the player to clear the stage) and, in contrast, the less the number of dices on the gaming machine and greater the third value for the first numeric value selection device of dices on the player, the lower will be the difficulty level (with an increase in a probability for the player to clear the stage).

With such a gaming machine, increasing or decreasing both of or one of the third value for gaming machine side and the third value for player side enables the difficulty level to be adjusted for each stage and the difficulty level of each stage to be randomly altered for each execution of the game, providing a capability for a player to have no feeling of a monotony of a play.

Also, the “difficulty level” may not necessarily include numerically rated information and it doesn't matter if the “difficulty level” includes information that is hard to be numerically rated provided that it includes information whose difficulty levels can be simply distinguished from each other. For instance, values of the difficulty levels may include those which are expressed as “A, B, C, D . . . ”.

Further, with the gaming machine set forth above, the third value selection device may be set such that at least one of the third value for the first numeric value selection device and the third value for the second numeric value selection device is decided so as to allow a difference or a ratio between the third value for the first numeric value selection device and the third value for the second numeric value selection device to take a numeric value depending on the value of the difficulty level mentioned above.

For instance, suppose that the difficulty level of the stage is classified into three stages of “Low”, “Normal” and “High”. The gaming machines operates such that for the stage fixed in a difficulty level of “Low”, a difference between the number of dices on the gaming machine and the number of dices on the player lies in a value of “3”; for the stage fixed in a difficulty level of “Normal”, a difference between the number of dices on the gaming machine and the third value for the first numeric value selection device (the third value for player side) lies in a value of “2”; for the stage fixed in a difficulty level of “High”, a difference between the number of dices on the gaming machine and the number of dices on the player lies in a value of “1”; with such a difference being continued on a subsequent process.

To give an actual example, the dice number may be configured to allow alteration such that for the stage with the difficulty level of “Low” wherein the difference between the third value for the player side and the third value for gaming side lies in the value of “3”, the number of dices on the gaming machine is “2” and the number of dices on the player is “5”; for the stage with the difficulty level of “Normal” wherein the difference between the third value for the player side and the third value for gaming side lies in the value of “2”, the number of dices on the gaming machine is “4” and the number of dices on the player is “16”; for the stage with the difficulty level of “High” wherein the difference between the third value for the player side and the third value for gaming side lies in the value of “1”, the number of dices on the gaming machine is “5” and the number of dices o the player is “6”. A second embodiment of the present invention is proposed as a gaming machine that is operative to allow a player to play a game composed of a plurality of stages in which comparison is made between the number of dice-numbers of the gaming machine and the dice-numbers of the player for deciding a win and loss.

With the gaming machine of such a structure, increasing or decreasing the number of dices on the gaming machine enables the difficulty level of each stage to be adjusted while enabling the difficulty level of each stage to be randomly altered, enabling the player to have no feeling of monotony on a play.

Also, the “difficulty level” may not necessarily include numerically rated information and it doesn't matter if the “difficulty level” includes information that is hard to be numerically rated provided that it includes information whose difficulty levels can be simply distinguished from each other. For instance, values of the difficulty levels may include those which are expressed as “A, B, C, D . . . ”.

With a third embodiment according to the present invention, a gaming machine is proposed wherein a player is enabled to play a game with a plurality of stages wherein comparison is made between a dice-number of the gaming machine side and a dice-number of the player side for determining a win and loss.

With the gaming machine, the second numeric value selection device selects O-pieces of the second numeric values; and the third value selection device selects the third value in the range of P-pieces to Q-pieces; and further comprising: the first numeral value selection device selects the first numeral value by the number of the third value determined by the third numeric value selection device; wherein the O, P and Q take natural numbers, respectively, under a relationship expressed as O≦P<Q.

With such a gaming machine, increasing or decreasing the number of dices on the gaming machine enables the difficulty level of each stage to be adjusted while enabling the difficulty level of each stage to be randomly altered, enabling the player to have no feeling of monotony on a play.

Also, the “difficulty level” may not necessarily include numerically rated information and it doesn't matter if the “difficulty level” includes information that is hard to be numerically rated provided that it includes information whose difficulty levels can be simply distinguished from each other. For instance, values of the difficulty levels may include those which are expressed as “A, B, C, D . . . ”.

Furthermore, the machine of the present invention way take the form of a structure that includes a difficulty level display area through which a remaining stage number is notified. With the presence of such a difficulty level display area, the player has a capability of knowing difficulty levels of the remaining stages while predicting a difficulty level of a subsequent stage.

Moreover, with the gaming machine according to the present invention, it becomes possible for the player to enjoy a strategic game play in targeting to reliably win a game with a less number of bets or targeting a mass amount of payout with a less chance in winning the game upon consuming more number of bets.

To achieve the third object set forth above, a gaming machine of the present invention is proposed as a gaming machine that allows a player to play a game including a plurality of stages in which comparison is made between a dice-number of the gaming machine side and a dice-number of the player side for determining a wind and loss while enabling the player to perform the drawing on a Jackpot under a predetermined condition.

With the gaming machine, the game, to be executed by the gaming machine, is configured to allow a Jackpot to be executed when a predetermined condition is realized. The gaming machine further comprises: a bet value processor storing bet values forming the number of bets credited by the player at a start of the game; a Jackpot startup condition storage device storing a bet number condition, forming a condition under which a lottery is executed for the Jackpot, in a manner to be re-writable; and a game outcome processor operative to permit a game value to be paid out to the player depending on an outcome of the game while executing the lottery for the Jackpot when the number of bets, stored by the bet value processor, satisfies the bet number condition for executing the lottery for the Jackpot.

With such a machine, it becomes possible for the player to appropriately alter a bet condition needed for a Jackpot winning occurrence while enabling the player to enjoy a strategic number of bets selection.

With the gaming machine set forth above, the bet number condition may be arranged so as to include at least one of an upper limit value and a lower limit value of a range of the number of bets such as, for instance, the number of bets that forms a Jackpot startup condition. Also, the gaming machine may further an input device for overwriting the bet number condition stored in a Jackpot startup condition storage device. Such a structure results in a capability for the number of bets needed for the Jackpot winning occurrence to have a width that can be controllably varied while making it possible for a gaming machine manufacturer, from which the gaming machine is provided, and a facility operator for games to provide varied effects related to the Jackpot.

To achieve the fourth object, the gaming machine of the present invention is proposed as a gaming machine that allows the player to play the game composed of the plural stages in which the operation is executed to make comparison between the dice-number of the gaming machine side and the dice-number of the player side for determining the wind and loss.

With the gaming machine, the game, to be executed by the gaming machine, has a plurality of stages. The gaming machine further comprises: a bet value processor storing the number of bets paid out by the player; wherein the gaming machine determines a stage available to be played by the player from among the plurality of stages depending on the number of bets stored by the bet value processor.

Further, the gaming machine, set forth above, may take the form of a structure that further includes a Jackpot accumulation device (such as, for instance, a CPU or a Jackpot accumulation device) for permitting Jackpot values to be accumulated and stored whereby the operation is executed to determine an availability of winning a premium depending on the Jackpot value associated with the number of bets stored in the Jackpot value processor.

With the gaming machine of such a structure, the availability of the winning of the Jackpot is determined depending on the size of the number of bets, enabling the provision a game that makes it possible to permit the player to enjoy upon strategically taking consideration whether to select a game on a high risk and high return basis or whether to select a game on a low risk and low return basis.

### BRIEF DESCRIPTION OF THE DRAWINGS

FIG. 1 is an external perspective view of a gaming machine.

FIG. 2 is a view showing a control panel.

FIG. 3 is a block diagram of the gaming machine.

FIG. 4 is a functional block diagram of the gaming machine.

FIG. 5 is a view showing an exemplary data structure of stage information.

FIG. 6 is a view showing an exemplary data structure of player-side information.

FIG. 7 is a view showing a dice combination table.

FIG. 8 is a view showing a payout magnification table.

FIG. 9 is a flowchart showing an exemplary main operation.

FIG. 10 is a flowchart showing an exemplary stage executing operation.

FIG. 11 is a view showing an exemplary screen to be displayed over a display.

FIG. 12 is a view showing an exemplary screen to be displayed over a display.

FIG. 13 is a view showing an exemplary screen, to be displayed over a display, upon shift from the screens shown in FIGS. 11 and 12.

FIG. 14 is a view showing an exemplary screen, to be displayed over a display, upon shift from the screen shown in FIG. 13.

FIG. 15 is a view showing an exemplary screen, to be displayed over a display, upon shift from the screen shown in FIG. 14.

FIG. 16 is a view showing an exemplary screen, to be displayed over a display, upon shift from the screen shown in FIG. 15.

FIG. 17 is a view sing an exemplary screen, to be displayed over a display, upon shift from the screen shown in FIG. 16.

FIG. 18 is a view showing an exemplary screen, to be displayed over a display, upon shift from the screen shown in FIG 17.

FIG. 19 is a view showing an exemplary screen, to be displayed over a display, upon shift from the screen shown in FIG. 18.

FIG. 20 is a view showing an exemplary screen, to be displayed over a display, upon shift from the screen shown in FIG. 19.

FIG. 21 is a functional block diagram of a stage information generator of a second embodiment.

FIG. 22A is a view showing an exemplary data structure of stage information of the second embodiment.

FIG. 22B is a view showing exemplary intermediate data for determining a number of pieces of CPU-side dice of the second embodiment.

FIG. 22C is a table showing a number of pieces of CPU-side dice of the second embodiment.

FIG. 23 is a flowchart showing an exemplary stage information generating operation of the second embodiment.

FIG. 24 is a view showing an exemplary screen to be displayed over a display of the second embodiment.

FIG. 25A is a view showing an exemplary screen to be displayed over a display of the second embodiment.

FIG. 25B is a view showing another exemplary screen, separate from that of FIG. 25A, to be displayed over the display of the second embodiment.

FIG. 25C is a view showing an exemplary screen to be displayed over the display under a status where a game proceeds from a state, shown in FIG. 25B, in the second embodiment.

FIG. 26A is a view showing an exemplary screen to be displayed over the display of the second embodiment at the beginning of a stage with the number of pieces of CPU-side dice is three.

FIG. 26B is a view showing an exemplary screen to be displayed over the display of the second embodiment at the beginning of a stage with the number of pieces of CPU-side dice is four.

FIG. 27 is a block diagram of a gaming machine of a fifth embodiment.

FIG. 28 is a functional block diagram of the gaming machine of the fifth embodiment.

FIG. 29 is a flowchart showing an exemplary main operation of the fifth embodiment. FIG. 30 is a view showing an exemplary screen to be displayed over a display during a a game practiced in the fifth embodiment.

FIG. 31 is a functional block diagram of a gaming machine of a sixth embodiment.

FIG. 32 is a flowchart showing an exemplary main operation of the sixth embodiment.

FIG. 33 is a perspective view showing an overall structure of a slot machine of a seventh embodiment.

FIG. 34 is a block diagram for illustrating an internal structure of the slot machine.

FIG. 35 is a flowchart showing an operationa sequence of main operations between a start and end of the slot machine.

### DETAILED DESCRIPTION OF THE INVENTION

Now, referring to the accompanying drawings, detailed description is made of embodiments deemed to be best for carrying out a gaming machine according to the present invention. Also, the same or equivalent component parts bear the same reference numerals to omit duplicated description.

### 1. First Embodiment

[1.1. Outline of Game Available with Gaming Machine]

A gaming machine 1 of the presently filed embodiment functions as a machine to allow a player to play a game composed of one or more stages. An outline of the game to be provided by the gaming machine is described below.

The gaming machine 1 operates such that: M-pieces of first numeric values (first dice-numbers) are selected by a first numeric value selection device (a player-side numeric value selection device) which functions as a numeric value selection device for rendering the gaming machine 1 to randomly select integral values from 1 to 6 for the player (step 1), M-pieces of selected first numeric values are stored in a first storage device (step 2), N-pieces of numeric values (second dice-numbers) are selected by a second numeric value selection device (a machine-side numeric value selection device) which functions as a numeric value selection device for randomly selecting integral values from 1 to 6 for the gaming machine)(step 3), N-pieces of selected second numeric values are stored in a second storage device (step 4). Moreover, both N- and M-pieces of numeric values represent natural numbers and may selectively include any number provided that the number establishes the relation as expressed as N≦M.

Next, the gaming machine 1 makes comparison between the N-piece of dice-numbers (a second numeric value) of the gaming machine side and the M-pieces of dice-numbers (first numeric value) of the player side (step 5) whereby if either the N-pieces of dice-numbers, among the M-pieces of dices of the player, matches the N-pieces of dice-numbers of the gaming machine, then, determination is made that the player clears the relevant stage upon which the player is permitted to proceed to a subsequent stage (step 6). Such determination is made with a win and loss determination device.

The player clears the respective stages in such a way and if the player clears all the stages forming the relevant game, determination is made that the player wins the game. When the player wins the game, the gaming machine 1 payout a premium (coins or the like) to the player.

Also, if the player becomes hard to clear any of the stages, then, determination is made at such a timing that the player loses the game, at which the game is consequently terminated. In such cases, no premium is paid out to the player or the premium is drastically reduced to a less value than that paid out when the player wins the game.

However, the gaming machine may configure to provide the player with a replay right under a predetermined condition. With the replay right given to the player, no game is finished even when the player undergoes a difficulty in clearing a certain stage and the player is permitted to challenge the relevant stage again for continuously playing the game.

Also, the present invention is described below in conjunction with assumption wherein the number of dices on the gaming machine includes two pieces (N=2) and the number of dices on the prayer includes five pieces (M=5). That is, the first numeric value selection device selects and stores five integral values (first numeric values) and the second numeric value selection device selects and stores two integral values (second numeric values). Of course, the present invention is not limited to such a number of dices.

Moreover, although the “dice” is displayed over the gaming machine in a configuration with a hexahedron normally having one to six spots, the “dice”, defined in this description, is not limited to such a configuration and has a concept involving a dice formed in an L-hedron (“L” representing a natural number greater than 4) available for the natural number to appear from 1 to “L” at an equivalent probability.

[1.2. Exemplary External Structure of Gaming Machine]

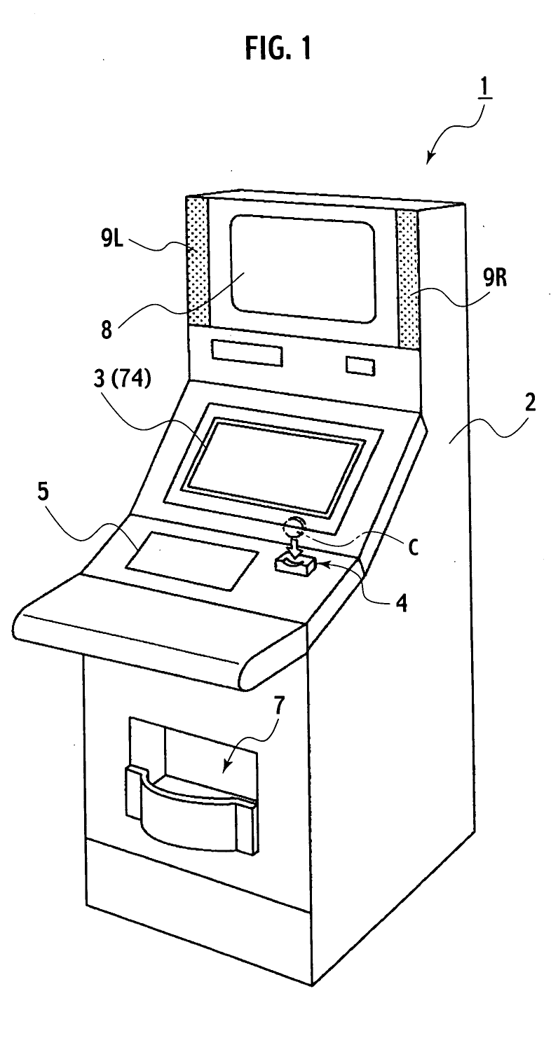

FIG. 1 is a perspective view of an overall external appearance showing a gaming machine 1 of a first embodiment. The gaming machine 1 is comprised of a cabinet 2 on which a display 3 is mounted. The display 3 is made of a liquid crystal display panel for displaying a game screen or the like.

Further, the display 3 has a front surface on which a touch panel sensor 74 is disposed to allow a player to touch a soft button (not shown), displayed over the display 3, whose touched state is detected to permit an input result, associated with the operation made by the player, to be inputted to the gaming machine 1.

A coin insertion slot 4 is located on the cabinet 2 in front of the display 3 at a lower area thereof for permitting the insertion of gaming medium (hereinafter referred to as a “coin”), such as a medal, a token, a chip or the like, to be credited in exchange of a game. The coin inserter 4 may take the form of a structure composed of a bill insertion slot, such as a bill valid device, appropriately mounted on the cabinet 2 to allow i player to use a bill as game-value-medium for playing the game provided by the gaming machine 1.

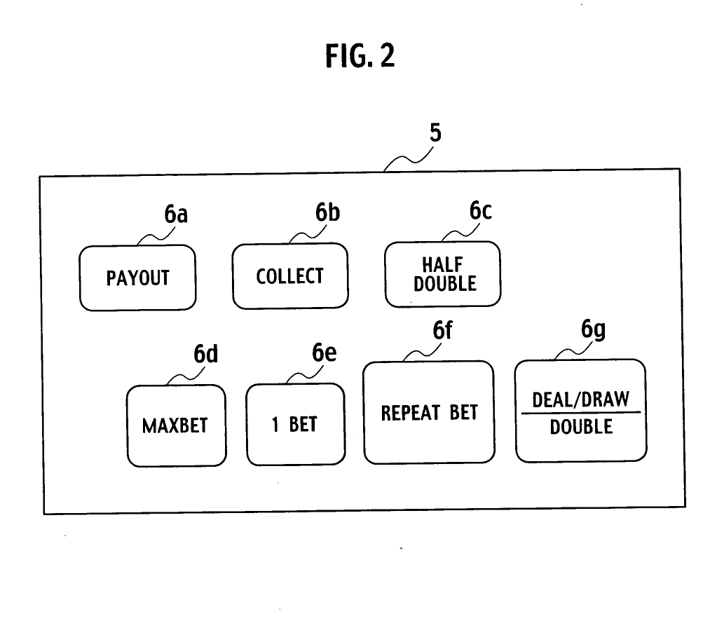

A control panel 5 is disposed on the cabinet 2 at a lower area of the display 3 and functions as an input device for the player. The control panel 5 takes the form of the substantially same structure as that of the state-of-the-art gaming machine for the player to input a command to the gaming machine 1 and, with the presently filed embodiment, includes seven buttons 6a to 6g provided in a manner as shown in FIG 2.

That is, the control panel 5 is comprised of a “PAYOUT” button 6a operative to allow the gaming machine 1 to pay out coins to a player, a “COLLECT” button 6b through which a command is applied to the gaming machine 1 at the end of a stage so as to cause the operation to proceed to a subsequent stage, a “HALF DOUBLE” button 6c operative to command a help function to be executed, a “MAXBET” button 6d operative to permit the number of coins with the allowable maximum value, involved in the number of coins credited in the gaming machine 1, to be used for a bet, a “1 BET” button 6e operative to permit “1” to be used from among the number of coins, credited in the gaming machine 1, for the bet, a “REPEAT BET” button 6f operative to permit the same number of coins as that of coins, bet in a preceding cycle, to be used from among the number of coins credited in the gaming machine 1 for the bet, and a “DEAL/DRAW” button 6g operative to cause the gaming machine 1 to start a game at the end of the bet.

Turning back to FIG. 1, the exemplary external structure of the gaming machine 1 is continued in description.

A sub-display 8 is mounted on the cabinet 2 at an upper area thereof to provide variable display of information and image (such as, for instance, a payout number-of-coins table, a dice-winning-combination table described below, and a cutline of a game content), with no direct relation with the game, on an as-needed basis. Also, a pair of speakers 9L, 9R are mounted on the cabinet 2 on both sides of the sub-display 8 for reproducing outputs such as a voice and music.

In the meanwhile, a coin receiving tray 7 is mounted on the cabinet 2 at a lower area thereof for permitting the player to receive the payout coins.

[1.3. Exemplary Internal Structure of Gaming Machine]

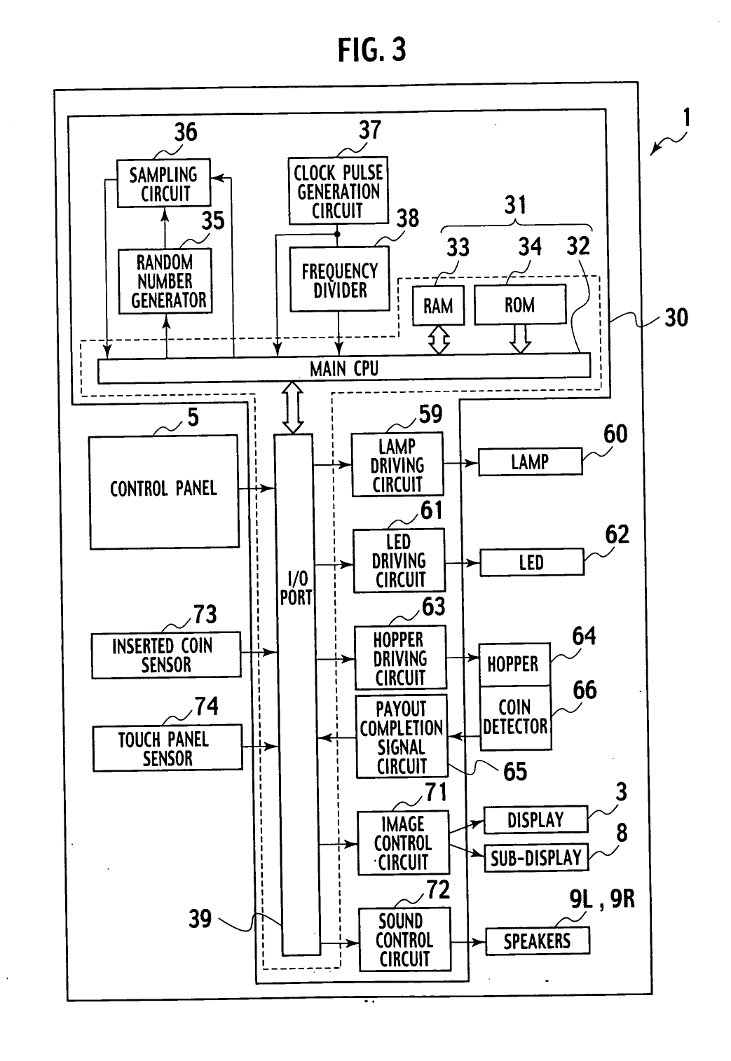

FIG. 3 is a block diagram showing an internal structure of the gaming machine 1. As shown in FIG. 3, the gaming machine 1 is comprised of a gaming-machine substrate 30 mounted inside the cabinet 2, and peripheral units connected to the gaming-machine substrate 30. A plurality of circuits is mounted on the gaming-machine substrate 30 around a microcomputer 31.

The microcomputer 31 is comprised of a main CPU (Central Processing Unit) 32, a RAM (Random Access Memory) 33 and a ROM (Read Only Memory) 34.

The main CPU 32 performs functions, in accordance with programs stored in the ROM 34, to permit signals to be inputted from various component parts of the control panel 5 via an I/O port 39 while permitting signals to be inputted to and outputted from other component parts for thereby achieving operational controls of a whole of the gaming machine 1. The RAM 33 stores therein data and programs, to be used for the main CPU 32 to perform the functions, and temporarily stores random number values to be sampled by a sampling circuit 36, which will be described below, after a game is started. The ROM 34 stores therein programs, to be executed by the main CPU 32, and permanent data.

Connected to the main CPU 32 are a random number generator 35, a sampling circuit 36, a clock pulse generation circuit 37 and a frequency divider 38. The random number generator 35 functions in accordance with a command delivered from the main CPU 32 to generate random number values in a certain range. The sampling circuit 36 responds to the command, delivered from the main CPU 32, for extracting an arbitrary random number from among the random number values resulting from the random number generation circuit 35 with the extracted random number being applied to the main CPU 32. The clock pulse generation circuit 37 generates a train of reference clock pulses for use in the main CPU 32 and the frequency divider 38 divides the reference clock pulses at a fixed frequency to provide signals that in turn is applied to the main CPU 32.

Mounted on the gaming-machine substrate 30 are a lamp driving circuit 59, an LED driving circuit 61, a hopper driving circuit 63, a payout completion signal circuit 65, an image control circuit 71 and a sound control circuit 72, all of which are connected to the main CPU 32 through the I/O port 39.

The image control circuit 71 that performs control operations for images to be displayed over the display 3 and sub-display 8, and the sound control circuit 72 that performs controls of sounds to be reproduced by the speakers 9L, 9R.

The lamp driving circuit 59 outputs a signal to the lamp 60 for turning on the sane, thereby permitting the lamp 60 to be turned on and off during a period in which a game is executed. Turning on and off the lamp 60 allows visual effects to be provided on the game. The LED driving circuit 61 controls a blinking display of the LED 62. The LED 62 provides a credit number display and a winning number display or the like. The hopper driving circuit 64 functions as a device by which the operation is executed to drive a hopper 64 in accordance with control, executed by the CPU 32, to cause the hopper 64 to pay out the coins, functioning as a game value, whereby the coins are shot out to the coin receiving tray 7 for executing the payout of the coins to the player.

The payout completion signal circuit 65 is connected to a coin detector 66, by which the number of coins, paid out from the hopper 64, is measured, and data indicative of the measured number of values is notified to the payout completion signal circuit 65. The payout completion signal circuit 65 counts the number of coins, detected by the coin detector 66, and operates such that when the resulting number of values reaches a predetermined number, a signal, notifying the completion in payout of the coins, is outputted to the main CPU 32.

The image control circuit 71 controls images to be displayed over the display 3 and sub-display 8, respectively, thereby permitting various images such as symbol images, described below, to be displayed over the display 3 and sub-display 8.

The image control circuit 71 is comprised of an image control CPU, a work RAM, a program ROM, an image ROM, a video RAM and a VDP (Video Display Processor). The image control CPU operates in accordance with an image control program, preliminarily stored in the program ROM, depending on parameters preset in the microcomputer 31 to determine images (symbol images or the like) to be displayed over the display 3 and sub-display 8. The work RAM is configured as a temporary storage device that is used for the image control CPU to execute the image control program.

The program ROM stores the image control program and various selection tables or the like. The image ROM stores character images and image data such as dot data, by which background images are formed. The video RAM is configured as a temporary storage device when forming images with the VDP. The VDP includes a control RAM for generating image signals depending on display contents of the display 3 and sub-display 8 determined by the image control CPU, with the resulting various image signals being outputted to the display 3 and sub-display 8.

The sound control circuit 72 controls sounds such as music and effect sounds, to be reproduced by the speakers 9L, 9R, depending on commands from the main CPU 31.

Further, connected to the microcomputer 31 are the control panel 5 and the touch panel sensor 74, which play a role as the input devices as mentioned above, and a coin sensor 73 that detects the coins being inserted from the coin inserter 4 to allow the resulting detection signal to be outputted to the microcomputer 31. The microcomputer 31 executes the operation to allow a value, associated with the number of inserted coins, to be added to a credit in response to the detection signal.

[1.4. Function of Gaming Machine]

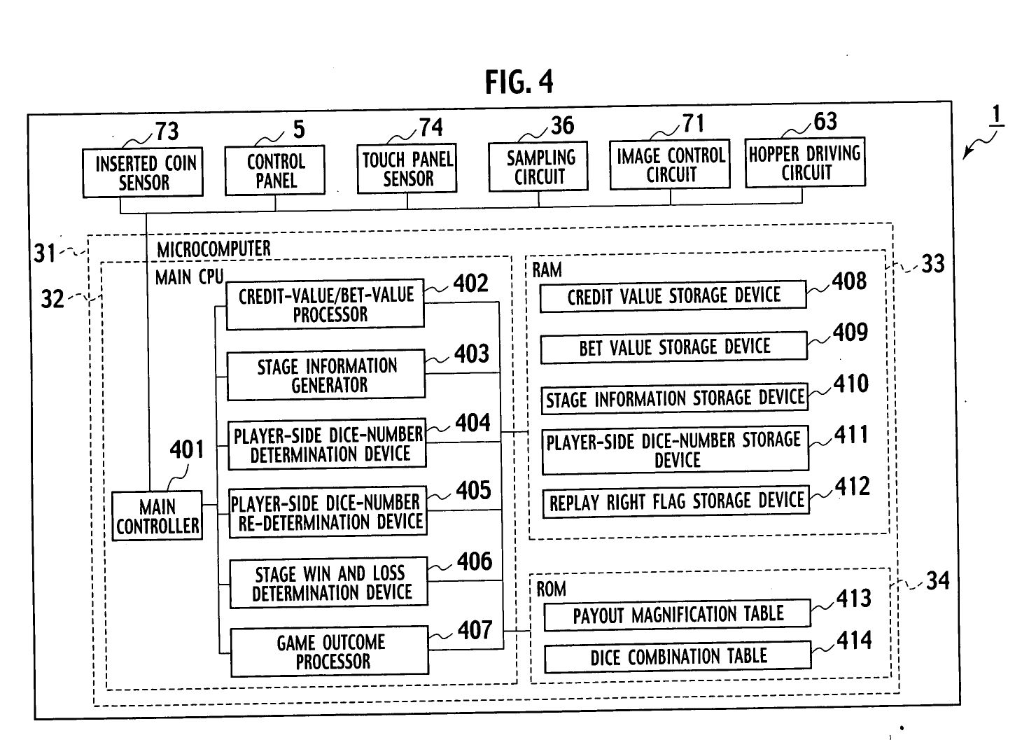

The gaming machine 1 of the presently filed embodiment has functions that are realized upon operation of the microcomputer 31, that is, the main CPU 32 to execute the programs stored in the ROM 34. Hereunder, description is made of various functions to be realized upon executing the programs with the microcomputer 31, more particularly, the main CPU 32. FIG. 4 is a functional block diagram of the gaming machine 1. With an example shown in FIG. 4, the main CPU 32 functions as a main controller 401, a credit-value/bet-value processor 402 operative to achieve delivery of data with the main controller 401, a stage information generator 403, a player-side dice-number determination device 404, a player-side dice-number re-determination device 405, a stage win and loss determination device 406 and a game outcome processor 407.

[1.4.1. Main Controller]

The main controller 401 totally controls various circuits of the gaming machine 1 and operations of various component parts thereof. More particularly, the main controller 401 is responsive to various input signals delivered from the inserted coin sensor 73, the control panel 3 and the touch panel sensor 74, respectively, to provide commands to the various component parts for startup and execution of associated operations. Moreover, the main controller 401 is responsive to requests from the various component parts to obtain random number values from the sampling circuit 36 for delivery to the various component parts. In addition, the main controller 401 transmits image generation commands to the image control circuit 71 such that images, associated with the operations of the various component parts, are displayed over the display 3 and sub-display 8. Moreover, the main controller 401 transmits a coin payout command to the hopper driving circuit 63 under a predetermined condition, that is, when the player depresses the “PAYOUT” button 6a, thereby causing the payout operation to be executed. Furthermore, for the purpose of providing effects depending on the operations of the various component parts, the main controller 401 transmits drive commands to the lamp driving circuit 59, the LED driving circuit 61 and the sound control circuit 72 (whose illustration is omitted in FIG. 4) to cause the effects of the lamp 60, the LED 62 and the speakers 9L, 9R to be provided.

The credit-value/bet-value processor 402, the stage information generator 403, the player-side dice-number determination device 404, the player-side dice-number re-determination device 405, the stage win and loss determination device 406 and the game outcome processor 407, all of which are controlled by the main controller 401, have functions described below.

[1.4.2. Credit-Value/Bet-Value Processor ]

The credit-value/bet-value processor 402, function as a bet value processor, is operative to cause the gaming machine 1 to pay out the coins to the player as a premium for the winning on the game while incrementing or decrementing a value hereinafter referred to as a “credit value”), corresponding to the number of coins owned by the player and held in the gaming machine 1, in response to commands delivered from the main controller 401 in accordance with the payout of the coins as a result of depressing the “PAYOUT” button 6a to allow the resulting credit value to be stored in a credit value storage device 408, which will be described below. Additionally, the credit-value/bet-value processor 402 allows the number of coins (herein referred to as a “number of bets”), bet by the player at a start of a game, to be stored in a bet value storage device 409 that will be described later.

More particularly, upon receipt of a coin insertion detection signal from the inserted coin sensor 73, the main controller 401 causes the credit-value/bet-value processor 402 to start up. Upon startup, the credit-value/bet-value processor 402 increments a credit value, stored in a credit value storage device 408, mentioned below, in response to the coin insertion detection signal.

Further, upon operation of the main controller 401 to receive a payout signal from the control panel 5, the main controller 401 starts up the credit-value/bet-value processor 402. Upon startup, the credit-value/bet-value processor 402 outputs a drive command to the hopper drive circuit 63 in response to the payout signal so as to allow the hopper 64 to pay out the coins while the number of payouts, executed by the hopper 64, to be decremented from a credit value stored in the credit value storage device 408.

Further, if the player wins on a game, the credit-value/bet-value processor 402 allows a value, associated with the number of coins won by the player, to be added to the value stored in the credit value storage device 408.

[1.4.3. Stage Information Generator]

The stage information generator 403, functioning as a CPU-side dice-number determination device (second numeric value selection device), has a function to generate stage information involving a CPU-side dice-number.

Upon operation of the control panel 5 to provide a notification indicative of detection that any of the buttons 6d, 6e, 6f is depressed after which the “DEAL/DRAW” button 6g is depressed, the main controller 401 starts up the stage information generator 403. Upon startup, the stage information generator 403 generates stage information, which in turn is stored in the stage information storage device 410. Stage information represents information including at least CPU-side dice-numbers. As used herein, the “CPU-side dice-numbers” refer to values corresponding to N-pieces of dice-numbers associated with N-pieces spots (dice-spots) formed on dices of the gaming machine, respectively.

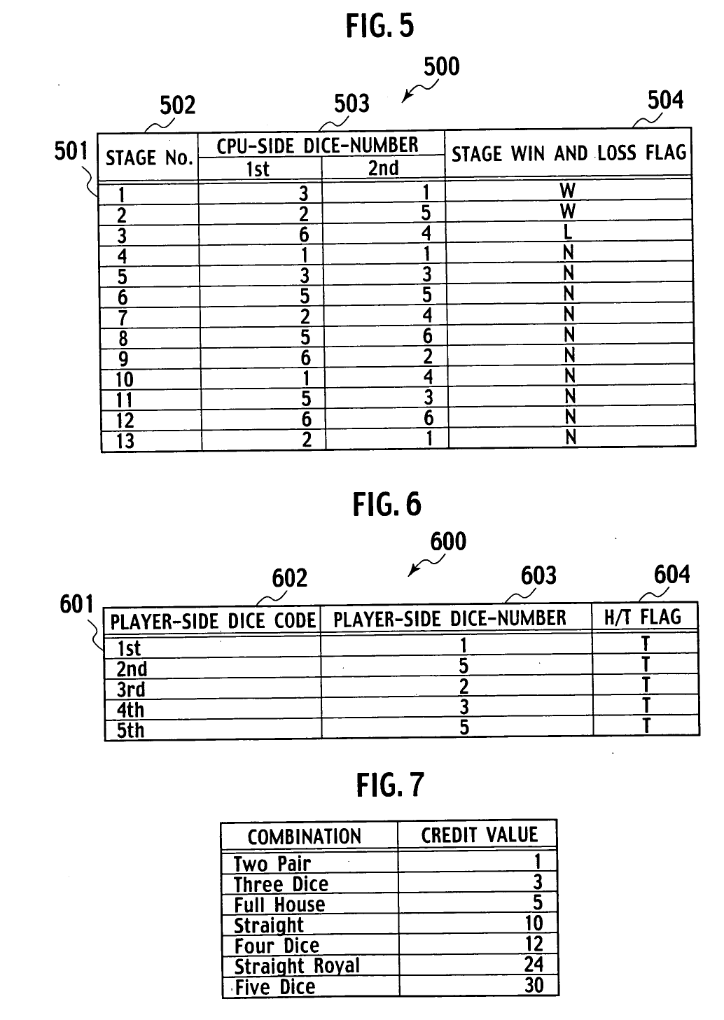

FIG. 5 shows an exemplary data structure of stage information. With such an example shown in FIG. 5, stage information 500 has one record for each stage involved in one game. A record 501 includes a stage number field 502 (second storage device), a Field 503 that stores a CPU-side dice-number (second numeric value), and a stage win and loss flag field 504 that stores a stage win and loss flag representing a win and loss state of the relevant stage. Also, with the structure of the presently filed embodiment, since the number of dices, provided on the gaming machine, is set to two pieces N=2), the Field 503 (second storage device) takes the form of a structure that stores two CPU-side dice-numbers. Moreover, with the structure of the presently filed embodiment, since the number of stages of one game includes 13 stages, stage information 500 includes 13 records 501. Also, in FIG. 5, a symbol “W” designates “WIN” and “L” designates “LOSS”.

Upon startup, the stage information generator 403 provides a request to the main controller 401 for two pieces of thirteen sets of random number values representing the random number values for the thirteen stages. The main controller 401 acquires two pieces of thirteen sets of random number values from the sampling circuit 36 for delivery to the stage information generator 403. The stage information generator 403 allows the thirteen sets of random number values to be stored in the Field 503 of the record 501 one by one.

Further, the stage information generator 403 allows a flag value “N”, indicating that an outcome of the relevant stage is pending, to be written in the stage win and loss flag field 504. This flag value is written into a flag value “W” under a situation where the relevant stage is executed with the player winning and, also, written into a flag value “L” when the player has lost.

[1.4.4. Player-Side Dice-Number Determination Device]

The player-side dice-number determination device 404, functioning as a first numeric value selection device, generates player-side information, involving a player-side dice-number (a first numeric value selected by the first numeric value selection device), to be stored. When the player depresses the “DEAL/DRAW” button 6g under a condition where the game is available to be started, the main controller 401 starts up the player-side dice-number determination device 404 in response to a depression detection signal from the control panel 5. Upon startup, the player-side dice-number determination device 404 generates player-side information that in turn is stored in a player-side dice-number storage device 411 in a manner as will be described below. More particularly, upon startup, the player-side dice-number determination device 404 provides a request to the main controller 401 for five random number values corresponding to five dice-numbers for the player. Upon receipt of this request, the main controller 401 acquires the five pieces of random number values from the sampling circuit 36 for delivery to the player-side dice-number determination device 404. The player-side dice-number determination device 404 generates player-side information to allow the five pieces of random number values to be stored as five pieces of player-side dice-numbers (first numeric value) for delivery to the player-side dice-number storage device 411. The player-side dice-number storage device 411 stores player-side information.

FIG. 6 shows an exemplary data structure of player-side information, Player-side dice information 600 has five records 601 corresponding to five dices, respectively. Each record 601 include a dice code field 602 that stores dice codes (1st to 5th) to be distinguished from other dices, a player-side dice-number field (first storage device) 603 that stores the dice-numbers, that is, five pieces of player-side dice-numbers (first numeric values) representing the random number values received from the main controller 401, and an “H/T” flag field 604 that stores a flag (HOLD/TURN; “H/T” flag) representing a difference between a hold and re-determination of the player-side dice-number to be stored in the first storage device 603. The “H/T” flag field 604 represents a field that stores either one of a flag value “H”, which means a hold of the player-side dice-number, and a flag value “T” which means a re-determination of the player-side dice-number.

That is, upon receipt of the five random number values from the main controller 401, the player-side dice-number determination device 404 stores these random number values in the player-side dice-number fields 603, respectively, while storing the flag value “T”, indicative of re-determination, in the “H/T” flag fields 604 of all the records 601. Also, it doesn't matter if no flag value “T” is stored but the flag value “H” is stored as an initial value.

[1.4.5. Player-Side Dice-Number Re-Determination Device]

Turning back to FIG. 4, description if made of a function of the player-side dice-number re-determination device 405. The gaming machine 1 of the presently filed embodiment is operative to allow the player to select re-determination of a whole of or a part of the five dice-numbers (first numeric values), representing the dice-numbers, determined by the player-side dice-number determination device 404. The player-side dice-number re-determination device 405 has a function to perform the re-determination of the player-side dice-numbers.

In particular, the player-side dice-number re-determination device 405 executes operations described below. As a certain stage is started, the display 3 provides a display of five dice-numbers determined by the player-side dice-number determination device 404. The player is able to allow the whole of or a part of the displayed dice-numbers to be re-determined to allow the gaming machine 1 to make re-determination in order to obtain a new dice-number advantageous to the player. The player touches a dice-number shown in the display 3, to be re-determined, and a dice-number, not to be re-determined, on the touch panel sensor 74 for designation.

The touch panel sensor 74 transmits a signal, indicative of a contact position, to the main controller 401 that in turn notifies a dice code, designated by the player, to the player-side dice-number re-determination device 405. The player-side dice-number re-determination device 405 alters the flag value of the “H/T” flag field in a way from “T” to “H” or from “H” to “T” in the record 601 (see FIG. 6) associated with the dice number notified from the main controller 401.

Thereafter, the player-side dice-number re-determination device 405 requests the random number values for several records with the flag value “T” referring to the flag value of the “H/T” flag fields 604 of player-side dice information 600.

Upon receipt of the request, the main controller 401 acquires the number of requested random number values from the sampling circuit 36 for delivery to the player-side dice-number re-determination device 405. The player-side dice-number re-determination device 405 operates to overwrite the received random number values in the player-side dice-number field (first numeric value storage device) 603 of the record 601 with a flag value “T” set in the “H/T” flag fields 604. By so doing, the selecting operation of the player results in the occurrence for a dice-number, stored in the field 600 for which the player has selected the re-determination, to be re-determined from among the dice-numbers on the player side. Also, depending on the selection made by the player, the occurrence may be possibly selected not to re-determine any dice-number.

[1.4.6. Stage Win and Loss Determination Device]

Upon receipt of a notification, indicative of the completed operation of the player-side dice-number re-determination device 405, the main controller 401 starts up the stage win and loss determination device 406. The stage win and loss determination device 406, functioning as a stage win and loss determination unit, performs determination on a win and loss of the relevant stage, while making discrimination whether or not the player-side dice-number (first numeric value), stored in the player-side dice-number storage device 411, matches a pre-determined combination.

In determining the win and loss on the stage, the stage win and loss determination device 406 makes comparison between the CPU-sided dice-numbers (second numeric values), stored in the Field 503 of the stage information storage device 410, and the player-side dice-numbers (first numeric values) stored in the field 600 of the player-side dice-number storage device 411. As a result of comparison, if all of the CPU-side dice-numbers lie in the player-side dice-numbers (first numeric value) stored in the player-side dice-number storage device 411, then, the stage win and loss determination device 406 makes determination that the player wins on the stage, thereby causing the stage win and loss flag of the record 501, associated with the relevant stage of the stage information storage device 410, to be updated to “W”. In other cases, the stage win and loss determination device 406 updates the stage win and loss flag of the record 501, associated with the relevant stage, to “L”.

Further, under circumstances where the stage win and loss determination device 406 makes determination that the player wins on the stage and a predetermined condition is satisfied, the operation is executed to write in a flag value (such as, for instance “1”), representing that the player acquires a replay right, in the replay right flag storage device 412. Tho predetermined condition represents a case wherein, for instance, the relevant stage number lies at “5”.

Further, in determining whether or not the player-side dice-number (first numeric value) establishes a predetermined combination, the stage win and loss determination device 406 makes determination referring to the dice combination table 414, mentioned below, whether or not the combination, described in the dice combination table 414, is established upon which if determination is made that the relevant combination is established, a premium associated with such a combination is paid out to the player. With the presently filed embodiment, it is supposed that the premium associated with the relevant combination includes credit values being added depending on the relevant combination.

FIG. 7 shows an example of the dice combination table 414. With this example, the dice combination table 414 is described in correspondence between dice combinations and credit values (the number of coins inserted by a player at a start of a game) relevant to the dice combinations. With the presently filed embodiment, although the dice combinations include combinations that are determined in accordance with combinations of pokers of playing cards, whether a kind of combinations is determined as dice combinations is not limited to the combinations of the pokers and any combination, attractive for the player to have entertaining and exciting values, may fall within a scope of the present invention. “Two Pair”, referred to in the example shown in FIG. 7, represents a winning combination) corresponding to Two Pair of the pokers and represents a combination when either two of the player-side dice-numbers have the same identical dice-numbers. “Three Dice”, functioning as a combination corresponding to “Three Cards” of the pokers, represents a combination that is established when either three of the player-side dice-numbers have the same identical dice-numbers. “Full House”, functioning as a combination corresponding to a “Full House” of the pokers, represents a combination that is established when either three of the player-side dice-numbers have identical dice-numbers and the remaining two have the same identical dice-numbers. “Straight” represents a combination, corresponding to a “Straight” of the pokers, which is established when the player-side dice-numbers have numbers that are continuous like “2, 3, 4, 5, 6” (with no object for an order). “Four Dice” represents a combination, corresponding to “Four Cards” of the pokers, which is established when either four of the player-side dice-numbers have identical dice-numbers.

“Straight Royal” represents a combination, corresponding to a “Royal Straight” of the pokers, which is established when the player-side dice-numbers have numbers that are continuous like “1, 2, 3, 4, 5” and the numbers get line up in an incremental order or decremental order from left to right. “Five Dice” represents a combination, corresponding to “Five Cards” of the pokers, which is established when all of the player-side dice-numbers have identical dice-numbers.

The stage win and loss determination device 406 makes determination referring to the dice combination table 414 to find whether the combination is established upon which if determination is made that either combination is established, an associated credit value is added to a value stored in the credit value storage device 408 to allow the value, resulting from addition, to be stored in the credit value storage device 408 as a new credit value.

The stage win and loss determination device 406 makes determination on a win and loss of the stage, mentioned above, and determination on the dice combinations while updating stage information and the credit value, after which an end of the operation is notified to the main controller 40.

[1.4.7. Game Outcome Processor]

Turning back to FIG. 4, a function of the game outcome processor 407 is described.

Upon receipt of a notification about the operation of the stage win and loss determination device 406, if the player wins a preceding stage with a remaining subsequent stage, the main controller 401 inquires the player as to whether to proceed to the subsequent stage through a user interface screen displayed over the display 3. If the player selects to proceed to the subsequent stage, then, the subsequent stage is started, while starting up the player-side dice-number determination device 404. In contrast, if the player selects not to proceed to the subsequent stage, then, the game outcome processor 407 is started up.

Upon start up, the game outcome processor 407 executes the payout operation referring to the payout magnification table 413, which is described below.

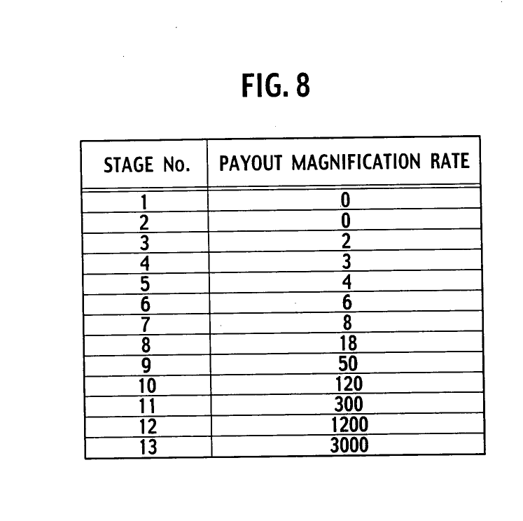

FIG. 8 shows an example of the payout magnification table 413. With this example, the payout magnification table 413 is described with a payout magnification rate determined for each stage. The game outcome processor 407 executes the operation to pay out a value, resulting from multiplying a numeric value of the relevant magnification rate to a number of bets stored in the bet value storage device 409, as the number of payout coins. For instance, if the relevant stage lies on a ninth stage with the number of bets of “5”, then, the payout magnification rate lies at “50” and, thus, the number of payout coins in outcome is calculated as 5×50=250.

Thus, the game outcome processor 407 determines the number of payout coins to the player, referring to the payout magnification table 413, with the number of determined coins being notified to the main controller 401. Upon receipt of the notification related to the number of coins, the main controller 401 drives the hopper driving circuit 63 in a way either to allow the number of notified coins to be discharged or to allow a value, equivalent to the number of notified coins, to be added to a value stored in the credit value storage device 408 and stored therein as a new credit value.

If the player loses in the preceding stage, the game outcome processor 407 refers to a flag value, stored in the replay right flag storage device 412, upon which if the flag value equals to “1” indicating the player has the replay right, then the game outcome processor 407 provides a notification to the main controller 401 for executing the replay. On the contrary, if the flag value equals to “0” indicating the absence of the replay right, the game outcome processor 407 executes the payout operation mentioned above.

Furthermore, if the player clears all the stages available to be executed in the absence of remaining stage, the game outcome processor 407 executes the payout operation, while providing a request to the main controller 401 for execution of an ending effect. Upon receipt of such a request, the main controller 401 executes operations to praise the player for his winning through provision of a predetermined ending effect upon rendering the image control circuit 71 operative to display an ending movie over the display 3.

Turning back to FIG. 4, description is continued of a function of the microcomputer 31. The microcomputer 31 includes a RAM 33 that functions in cooperation with the main CPU 32, and a ROM 34. The RAM 33 functions as the credit value storage device 408 mentioned above, the bet value storage device 409, the stage information storage device 410, the player-side dice-number storage device 411 and the replay right flag storage device 412. These component parts have been already described above and description of the same is herein omitted.

Further, the ROM 34 stores the payout magnification table 413 and the dice combination table 414 and functions as these tables. These tables have been already described above and, so, description of the same is herein omitted. With that, description of the structure and functions of the machine 1 comes to the end.

[1.5. Exemplary Operation of Gaming Machine]

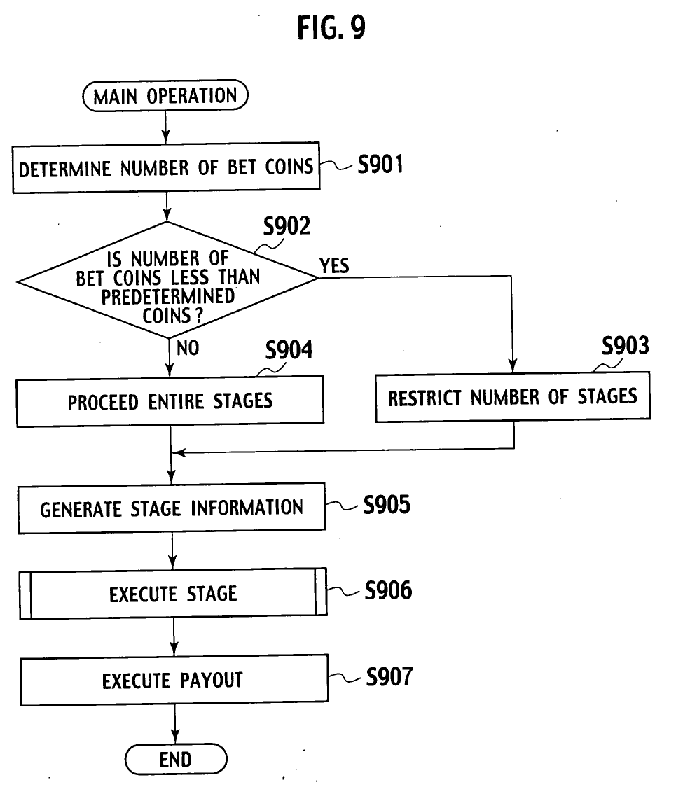

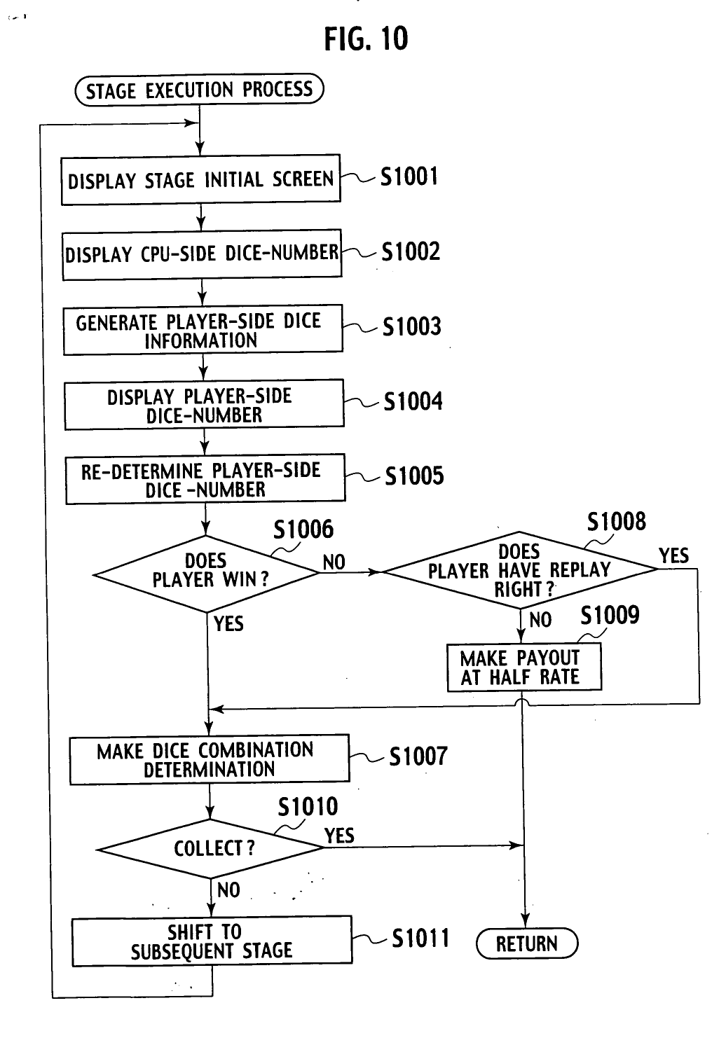

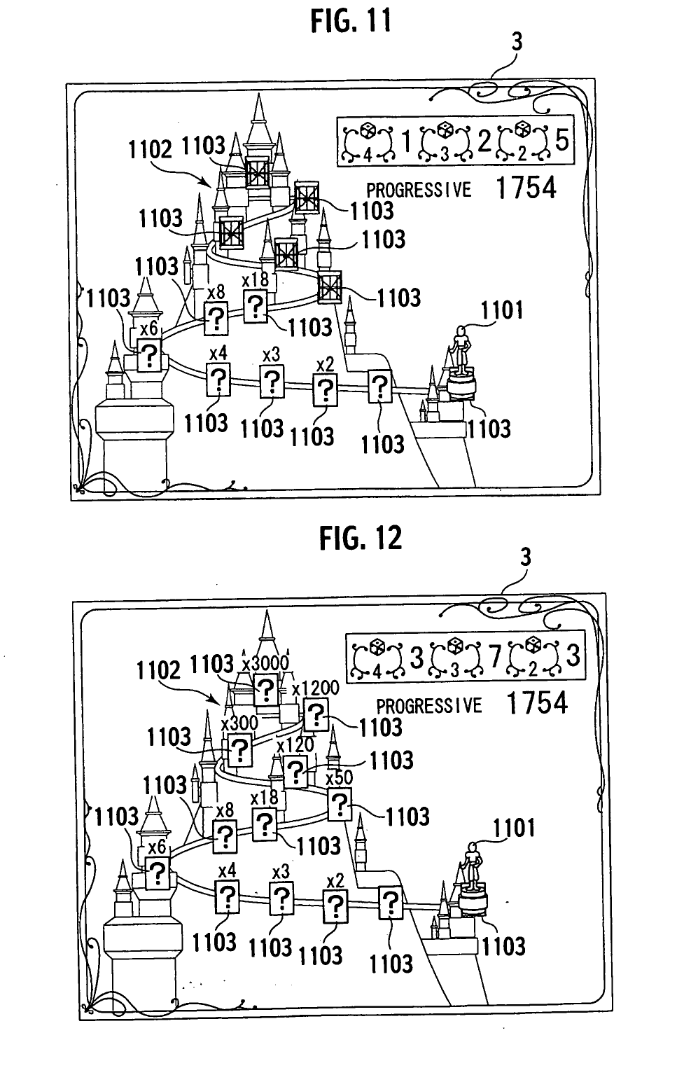

Subsequently, exemplary operations of the gaming machine 1 mentioned above are described with reference to FIGS. 9 to 20. FIG. 9 is a flowchart showing an example of main operation of the gaming machine; FIG. 10 is a flowchart showing an example of stage executing operation involved in the main operation; and FIGS. 11 to 20 are views showing examples of a game screen and the user interface screen to be displayed over the display 3 during main operation or game executing operation.

[1.5.1. Main Operation]

First, the main operation, to be executed by the gaming machine 1 of the presently filed embodiment, is described with reference to FIG. 9, With an example shown in this Figure, it is premised that the gaming machine 1 is powered on and an initial operation, such as clearing of the RAM 33, has been completed.

Initially, the main CPU 32 (the main controller 401 and the credit-value/bet-value processor 402) executes bet number determining operation (S901). The bet number determining operation represents operation to urge a player to credit how many numbers of coins are bet on a game which the player is going to play. As the bet number determining operation is started, the main CPU 32 (main controller 401) allows the display 3 or sub-display 8 to display messages and screens to urge the player to determine a “BET” number and waits for an input from the player. Upon operation of the player to depress the “MAX BET” button 6d, the “1-BET” button 6e and the “REPEAT” button 6f, the number of bets is inputted to the gaming machine 1. The main CPU 32 (credit-value/bet-value processor 402) responds to the operation of the player to depress the “DEAL/DRAW” button 6g to allow the “BET” number to be set in concrete and allows a value, associated with the determined “BET” number, to be stored in the bet value storage device 409. With that, the “BET” number determining operation is completed.

Then, the main CPU 32 (main controller 401) makes determination whether or not the “BET” number, stored in the bet value storage device 409, is below or exceeds a pre-determined value (S902). If the “BET” number, stored in the bet value storage device 409, is below the pre-determined value (with “YES” in S902), the main CPU 32 (main controller 401) executes a stage number limiting operation such that the operation is set to allow the player to be able to play a game on the way half of an entire stage involved in one game (S903). When this takes place, the main CPU 32 (main controller 401) allows a screen (see FIG. 11), informing the player with a possibility of challenging the game to the middle thereof, to be displayed over the display 3.

FIG. 11 shows an exemplary screen to be displayed over the display 3 in step S903. With the example shown in this Figure, the screen represents a game of a story that allows a player character 1101, that functions as an expert in unlocking, to obtain a picture of an apparitional artist, wherein a certain ancient castle is decorated, upon unlocking. The ancient castle includes entire stage components of pictures (thirteen sheets in the presently filed embodiment) corresponding to the stages and is story-driven with the respective pictures being locked with keys, respectively. Of course, the gaming machine of the present invention is not limited to such a story.

With the exemplary screen shown in FIG. 11, the ancient castle takes the form of a background with room icons 1103, associated with respective stages, being displayed for rooms from a first room (first stage) to a thirteenth room (a thirteenth stage). With the exemplary screen in step S903, the entire stages has no permissions to be challenged and upper five rooms among the thirteen rooms are displayed with relevant room icons that can not be unlocked.

Also, as the player wins on the stage and clears the stage, the player character 1101 gets through the room icon 1103 that corresponds to a stage on which the player subsequently plays, informing the player with a progress of a game.

Turning back to FIG. 9, description of the main operation is continued.

On the contrary, if in determination in step S902 the bet number (number of bets), stored in the bet value storage device 409, exceeds the pre-determined value (with “No” in S902), the main CPU 32 (main controller 401) executes entire stage operations in which all of the entire stages, contained in one game, is set to be playable (S904). When this takes place, the main CPU 32 (main controller 401) allows the display 3 to display a screen (see FIG. 12) informing the player with a capability of challenging to play to a final stage.

FIG. 12 shows an exemplary screen to be provided on the display 3 in step S904.

With the example shown in this Figure, while the screen is substantially similar to that shown in FIG. 11, all of the thirteen rooms are displayed with symbols “?”, which indicates the player can challenge the rooms.

Turning back to FIG. 9, description of the main operation is continued.

As the executions of steps S903 or S904 are terminated, the main CPU 32 (stage information generator 403) executes stage information generating operation to determine a CPU-side dice-number for each stage using random numbers for generating stage information 500, shown in FIG. 5, involving the CPU-side dice-number and storing the same in the RAM 33 (stage information storage device 410). Also, an alternative may be configured such that during the stage information generating operation to be executed followed by step S903, the CPU-side dice-numbers (second numeric values) from the first stage to the eight stage are automatically determined whereas no CPU-side dice-number from the ninth stage to the thirteenth stage is determined.

As the stage information generating operation is terminated (S905), the main CPU 32 (main controller 401) executes the stage executing operation (S906). FIG. 10 is a flowchart showing one example of the stage executing operation. Hereunder, the stage executing operation is described with reference to FIG. 10.

Stage Executing Operation

As the stage executing operation is commenced, the main CPU 32 (main controller 401) executes stage initial screen display operation displaying a screen functioning as a use interface for a player to play a game (S1001).

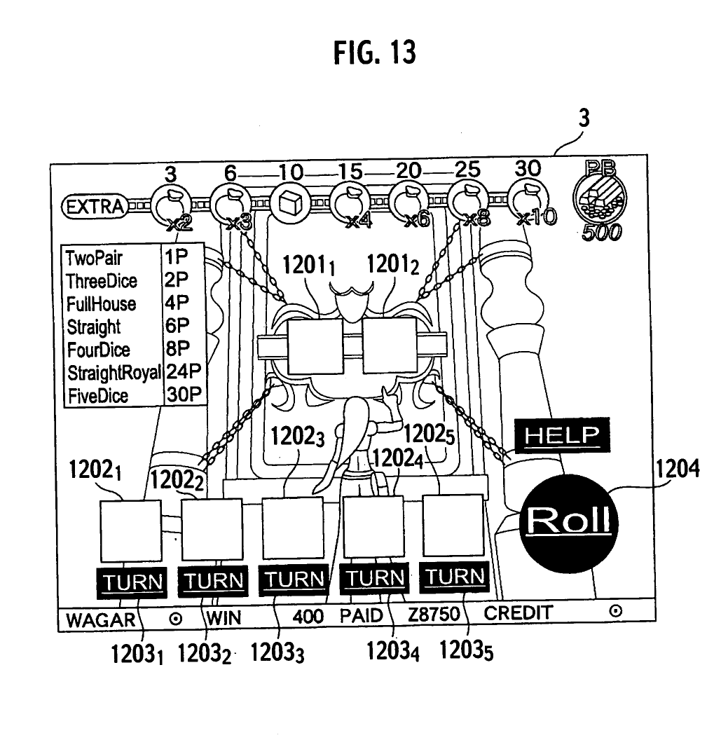

FIG. 13 shows an exemplary screen to be displayed during the stage initial screen display operation.

With this example, the screen includes CPU-side dice-number display areas 1201₁, 1201₂, functioning as areas for displaying two CPU-side dice-numbers (second numeric values) in front of a background picture under a status where the player character 1101 arrives in front of great doors at the front of rooms associated with the stage, and player-side dice-number display areas 1202₁, 1202₂, 1202₃, 1202₄, 1202₅ that functions as areas for displaying five player-side dice-numbers (first numeric values).

Further, H/T button areas 1203₁, 1203₂, 1203₃, 1203₄, 1203₅ are disposed on the screen at areas beneath the player-side dice-number display areas 1202₁, 1202₂, 1202₃, 1202₄, 1202₅, respectively, to give instructions to the player to hold or re-determine the dice-numbers. The “H/T” button areas 1203 operate such that as the player touches an area with his finger, the main controller 401 and the player-side dice-number re-determination device 405 are notified with information about whether intension “HOLD”, indicative of the player who desires the “holding”, is selected by the player or whether another intension “TURN”, which means the “re-determination”, is selected by the player upon depression of the touch panel sensor 74. Moreover, under a condition where the selection of either “HOLD/TURN” is fixed, if the player re-touches the “H/T” button area 1203, previously displayed in a status with “HOLD”, then, a display of the relevant area is shifted from the status “HOLD” to a status “TURN” whereas if the “H/T” button area 1203 is previously displayed in the “TURN”, then, a display of the relevant area is shifted from the status “TURN” to the status “HOLD”, thereby making it possible to freely perform the selective change in “HOLD”/“TURN”.

Furthermore, a roll button 1204 is placed in a right side of the “H/T” button 1203₅ for causing the dices, displayed in the “H/T” button areas 1203₁, 1203₂, 1203₃, 1203₄, 1203₅, to be rotatably displayed. As the player touches the roll button 1204 with his finger, the touch panel sensor 74 provides the main CPU 32 (main controller 401) with a notification that the roll button 1204 is operated by the player, upon which the main CPU 32 (main controller 401) allows the image control circuit 71 to execute rotary displays of the dices in the player-side dice-number display areas 1202₁, 1202₂, 1202₃, 1202₄, 1202₅, respectively.

Turning back to FIG. 10, description of the stage executing operation is continued.

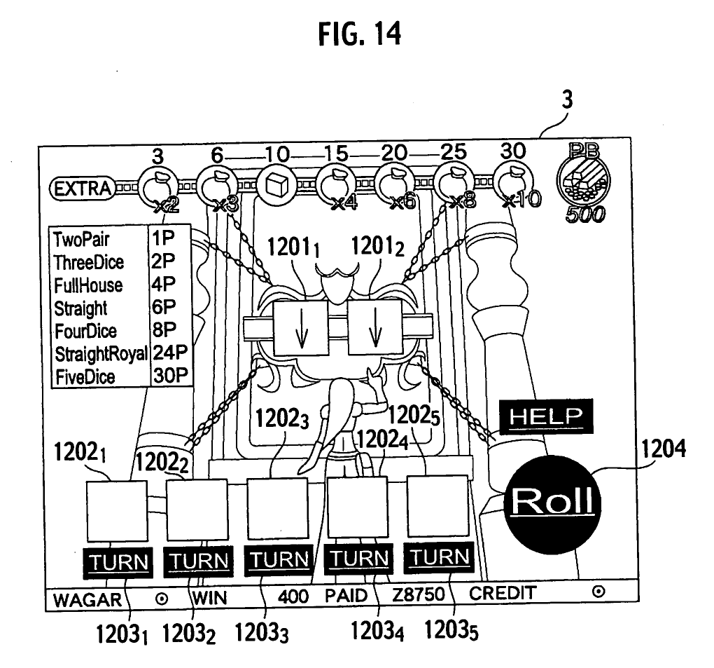

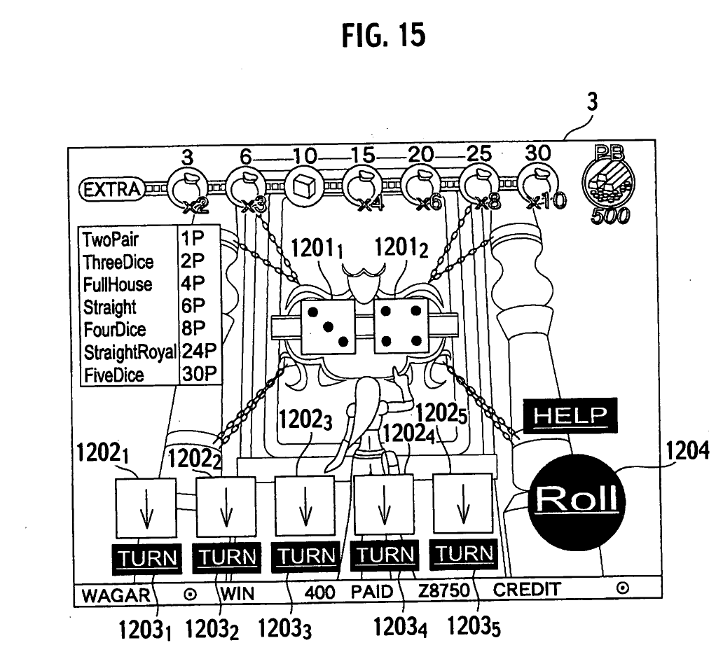

As the stage initial screen display operation is terminated (S1001), the main CPU 32 (main controller 401) executes the CPU-side dice-number display operation (S1002). This operation represents operation that allows stage information 500 generated in the stage information generating operation (S905), that is, images of dice-numbers associated with the CPU-side dice-numbers, to be displayed in the player-side dice-number display areas 1202₁, 1202₂. FIGS. 14 and 15 show exemplary screens to be displayed over the display 3 during the CPU-side dice-number display operation. The display 3 provides a display of rotating dices in the player-side dice-number display areas 1202₁, 1202₂, respectively, in a manner as shown in FIG. 14. After the dices are displayed upon rotating for a pre-determined time interval, the dices stop rotating, permitting images of determined dice-numbers to be displayed in the player-side dice-number display areas 1202₁, 1202₂, respectively (see FIG. 15). The dice-numbers, appearing in displayed images, become equivalent to the CPU-side dice-numbers of stage information 500 (see FIG. 5).

Turning back to FIG. 10, description of the stage executing operation is continued.

As the CPU-side dice-number display operation (S1002) is finished, the main CPU 32 (player-side dice-number determination device 404) generates player-side dice information 600, as shown in FIG. 6, and executes the player-side dice information generating operation to allow player-side dice information 600 to be stored in the player-side dice-number storage device 411 (S1003).

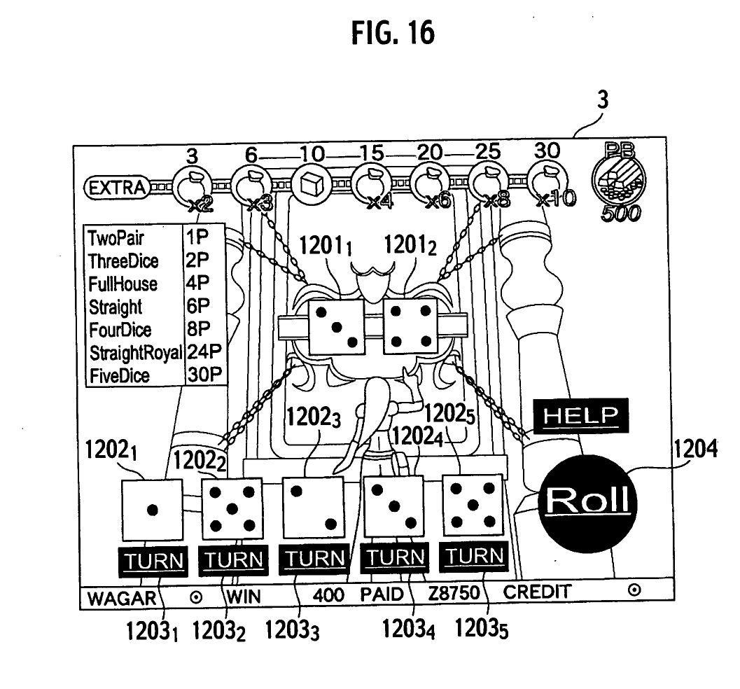

Then, the main CPU 32 (main controller 401) executes the player-side dice-number (first numeric value) display operation (S1004). This operation allows images of the dice-numbers, associated with the player-side dice-numbers (first numeric values) involved in player-side dice information 600 generated in the player-side dice information generating operation (S1003), to be displayed in the “H/T” button areas 1203₁, 1203₂, 1203₃, 1203₄, 1203₅, respectively, in a manner as shown in FIG. 16.

FIGS. 15 and 16 show exemplary screens to be displayed over the display 3 during the player-side dice-number display operation (S1004). During the player-side dice-number display operation (S1004), the display 3 displays rotating dices in the player-side dice-number display areas 1202₁, 1202₂, 1202₃, 1202₄, 1202₅, respectively, as shown in FIG. 15. After the dices are displayed in rotation for a pre-determined time interval, the rotations of the dices are caused to stop. When this takes place, images of dice-numbers resulting from determinations are displayed in the player-side dice-number display areas 1202₁, 1202₂, 1202₃, 1202₄, 1202₅, respectively, (see FIG. 16). The dice-numbers, appearing in the displayed images, become equivalent to the player-side dice-numbers (first numeric values) of player-side dice information 600 (see FIG. 6). With that, the player-side dice-number display operation is completed.

Subsequently, the main CPU 32 (player-side dice-number re-determination device 405) executes player-side dice-number re-determining ration (S1005). The player-side dice-number re-determining operation functions as operation for permitting the player to select a whole of or a part of five dice-numbers, pleriminary determined by the player-side dice-number determination device 404, only once for re-determination.

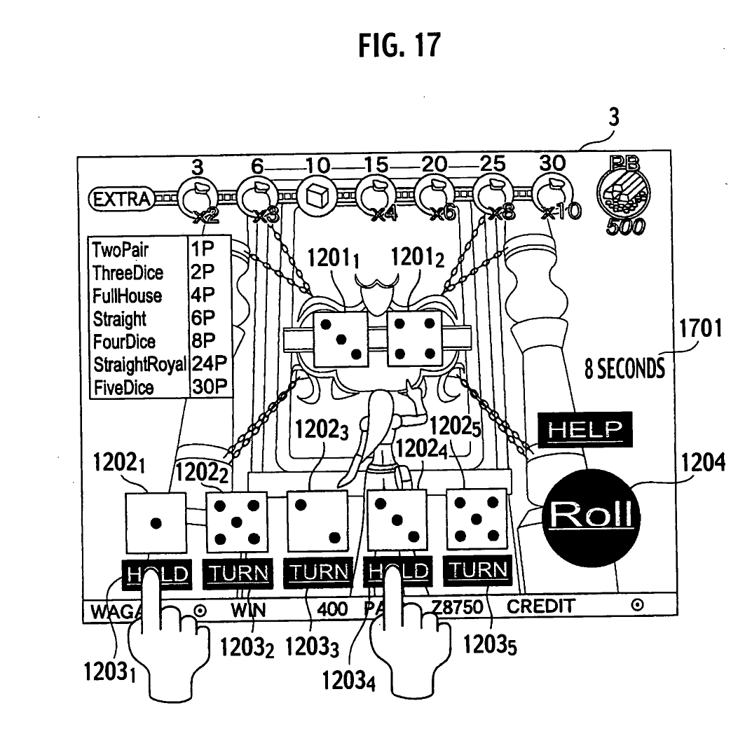

FIGS. 17 to 20 show exemplary screens to be displayed over the display 3 dub player-side dice-number re-determining operation (S1005).

FIG. 17 shows an example of a user interface input screen which in executing the player-side dice-number re-determining operation (S1005), allows the player to input information about which of the dice-numbers, among the dice-numbers displayed in the player-side dice-number display areas 1202₁, 1202₂, 1202₃, 1202₄, 1202₅, respectively, is to be held or re-determined during the player-side dice-number display operation (S1004). After the screen of FIG. 16 has been displayed, an image shits to a screen shown in FIG. 17. Although the screen of FIG. 17 has the substantially same content as that of FIG. 16, this screen is additionally provided with a remaining time display 1701 for the player to have a permission to select the dice-numbers for re-determination.

With this example, it is supposed that the player selects holding a dice-number in the leftmost position and a dice-number in a second position from the right, while leaving the other remaining dice-numbers for re-determination, and the player touches the “H/T” button areas 1203₁, 1203₄, associated with the dice-number in the leftmost position and the dice-number in the second position from the right, respectively, with his finger.

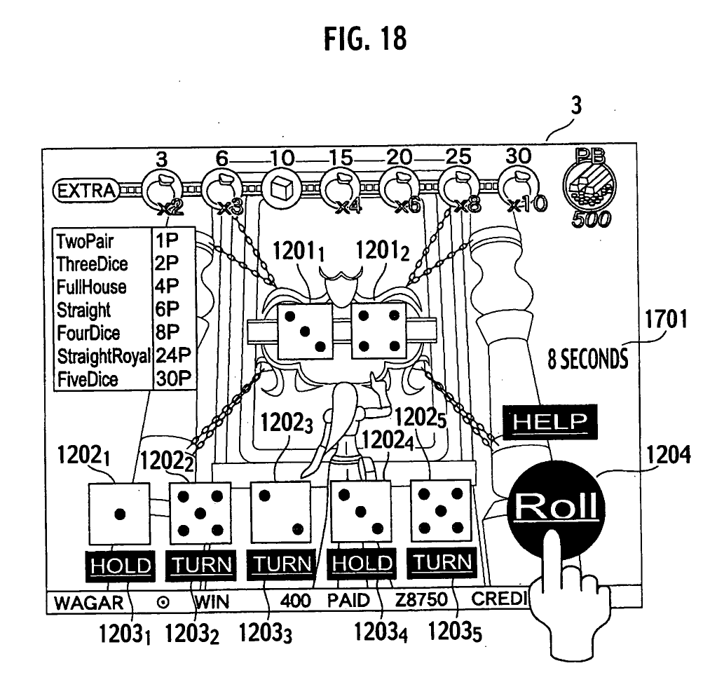

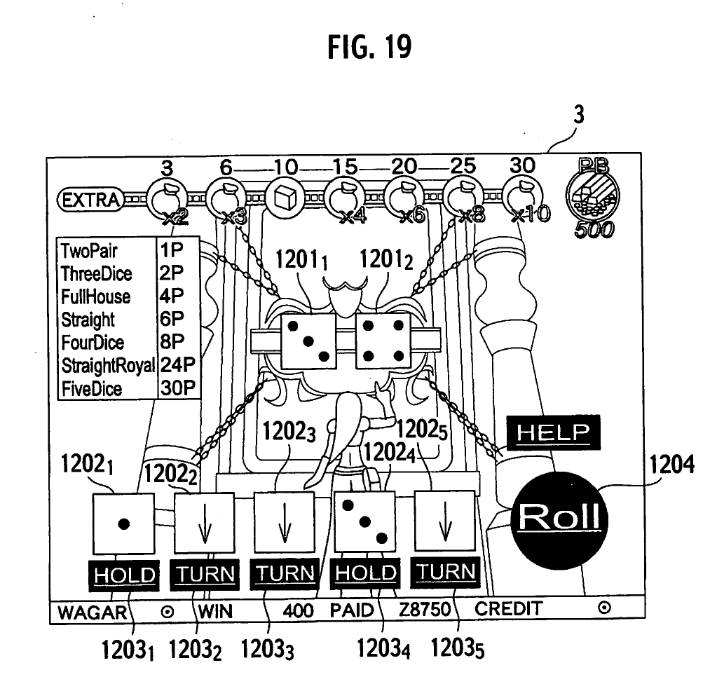

As the player touches the “H/T” button areas 1203₁, 1203₄ with his finger, the screen, shown in FIG. 17, is sifted to a screen shown in FIG. 18. With the exemplary screen shown in FIG. 18, the displays of the “H/T” button areas 1203₁, 1203₄ are switched over from the “TURN” state to the “HOLD” state. On the contrary, the displays of the “H/T” button areas 1203₂, 1203₃, 1203₅ remain unchanged in the “TURN” state. Here, if the player touches the rolling button area 1204 with his finger, the screen shifts to a screen shown in FIG. 19.

With the screen shown in FIG. 19, the dices are displayed in rotation on the player-side dice-number display areas 1202₂, 1202₃, 1202₅, associated with the “H/T” button areas 1203₂, 1203₃, 1203₅, respectively, which remain in display in the “TURN” state. When this takes place, the main CPU 32 (player-side dice-number re-determination device 405) allows a random number value, received from the main controller 401, to be overwritten and written in the player-side dice-number field 603 of the record 601 (see FIG. 6) associated with the player-side dice-number 10 display areas 1202₂, 1202₃, 1202₅.

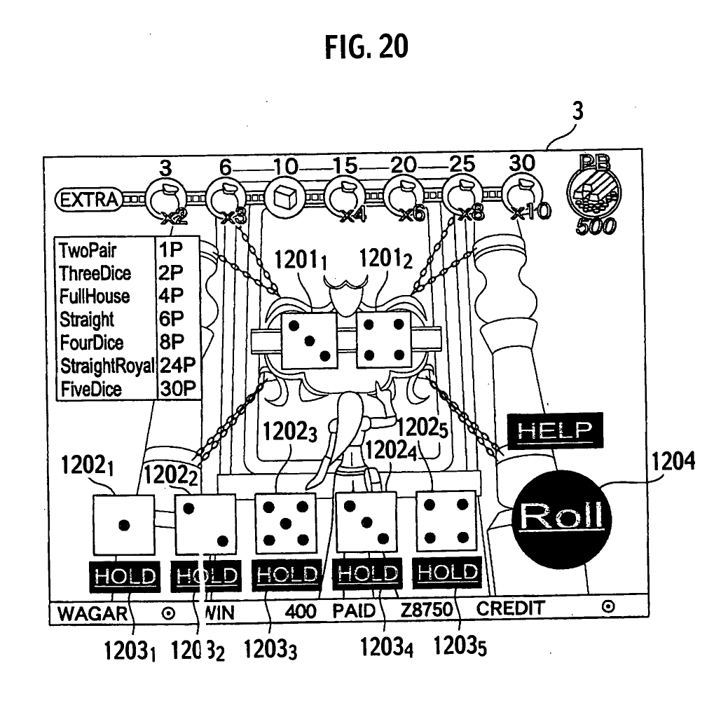

After the dices are displayed in rotation for a pre-determined time interval, the screen, to be displayed over the display 3, shifts to a screen shown in FIG. 20. With the screen shown in FIG. 20, the dices with newly selected dice-numbers are displayed in the player-side dice display areas 1202₂, 1202₃, 1202₅, respectively, depending on the dice-numbers that are overwritten and written in the player-side dice pot value field 603. With that, the player-side dice-number re-determining operation (S1005) is completed.

Turning back to FIG. 10, description of the stage executing operation is continued.

After the player-side dice-number re-determining operation (S1005) has been completed, the main CPU 32 (stage win and loss determination device 406) determines whether or not the player wins (S1006). That is, the main CPU 32 (stage win and loss determination device 406) determines the presence of a win and loss depending on whether or not the CPU-side dice-numbers and the player-side dice-numbers (first numeric values), stored in the player-side dice-number storage device 411, match each other. If the matching occurs in the dice-number, that is, when the first numeric value and the second numeric value match each other, the main CPU 32 (stage win and loss determination device 406) determines that the player wins and if no matching exists, then, determination is made that the player loses the stage.

If the main CPU 32 (stage win and loss determination device 406) determines that the player wins (with “Yes” in S1006), the main CPU 32 (stage win and loss determination device 406) executes dice combination determining operation to find whether or not the player-side dice-numbers (first numeric values), stored in the player-side dice-number storage device 411, establish a predetermined combination (S1007). If the predetermined combination is established, the credit-value/bet-value processor 402 is caused to execute the operation by which a credit value is added.

In contrast, if the main CPU 32 (stage win and loss determination device 406) determines that the player does not win (with “No” in S1006), the main CPU 32 (stage win and loss determination device 406) makes determination referring to the replay right flag storage device 412 to find whether or not the replay right is present. If determination is made that the replay right is present, the main CPU 32 (stage win and loss determination device 406) executes dice combination deter operation (S1007). On the contrary, if determination is made that no replay right is present, the main CPU 32 (stage win and loss determination device 406) executes half-rate payout operation (S1009) to render the hopper driving circuit 63 operative to pay out the number of coins, obtained when the winning occurs, at a half rate upon which the stage executing operation is completed.

By the way, as the dice combination determining operation (S1007) is completed, the main CPU 32 (main controller 401) inquires the player whether to so to a subsequent stage (S1010). If the player has no willing to go to the subsequent stage and wishes to have the payout of the coins that have been won, the player depresses the “COLLECT” button 6b. On the contrary, if the player wishes to continue playing on a subsequent stage, the player depresses the other button than the “COLLECT” button such as, for instance, the “DEAL/DRAW” button 6g.

If the “COLLECT” button is depressed (with “Yes” in S1010), the main CPU 32 (main controller 401) completes the stage executing operation upon which the operation is restored to the main operation. On the contrary, if no “COLLECT” button is depressed (with “No” in S1010), the main CPU 32 (main controller 401) executes the operation to shift to a subsequent stage (S1011), upon which the operation is returned to step S1001 to begin a stage initial screen display.

As the stage executing operation is completed, the main operation is restored and the main CPU 32 (game outcome processor 407) executes the payout operation referring to the payout magnification table 413. With that, description of the main operation is completed. As the main operation is completed, one game is terminated. Then, the gaming machine 1 returns to the status in step S901 again, in which the gaming machine 1 waits for the betting of the player in preparation for a subsequent stage. With that, description of the exemplary operation of the gaming machine 1 is completed.

### 2. Others

(1) The presently filed embodiment may be configured in a structure to enable the number of CPU dices to vary upon selection of a player at a start of a game. Since it stands that the greater the difference between the number of dices for the CPU and the number of the player-side dices, the lower will be the difficulty level of a game and, in contrast, the less the difference between the number of dices for the CPU and the number of the player-side dices, the higher will be the difficulty level of the game, the player becomes possible to enjoy the game with a proper difficulty level depending on skills of the player.

(2) With the presently filed embodiment, the present invention may be established even when using play equipment having a plurality of kinds of cards or tiles such as playing cards, Japanese playing cards and mah-jongg tiles.

(3) While the presently filed embodiment has been described with reference to a configuration wherein the CPU-side dice-numbers are determined for all of the first to thirteenth stages before the first stage is started at the start of the game, the present invention is not limited to such a configuration and it doesn't matter if only a CPU-side dice-number for each stage is determined in each case prior to the beginning of each stage.

Hereunder, a gaming machine of another embodiment according to the present invention is described with reference to the accompanying drawings.

### 3. Second Embodiment

[3.1. Outline of Game Provided By Gaming Machine]

The gaming machine of the presently filed embodiment takes the form of the same external appearance and internal structure as those of the gaming machine 1 of the first embodiment (see FIGS. 1 to 4), mentioned above, unless otherwise particularly described (see [1.2. Exemplary External Structure of Gaming Machine], [1.3. Exemplary Internal Structure of Gaming Machine] and [1.4. Function of Gaming Machine]) and, hence, duplicated description is herein omitted. Also, the gaming machine 1 of the presently filed embodiment functions as a device operative to allow a player to play a game formed of one or more stages. An outline of the game to be provided by the gaming machine 1 is described below. First, the gaming machine 1 of this embodiment executes the operation in each stage to determine either one of the N-pieces to M-pieces of dices to be the number of pieces of dices on a site of the gaming machine 1 to be used in such a stage (wherein the number of dices determined for the site of the gaming machine 1 is supposed to include X-pieces provided that “X” is a natural number that satisfies the relationship expressed as N≦X≦M).

Next, the gaming machine 1 executes the operation to randomly determine spots (second numeric values) of X-pieces of dices on the site of the gaming machine 1, while permitting L-pieces of dices on a site of the player to be rolled for determining dice-numbers (first numeric values) of the X-pieces of the dices on the site of the player. Also, all the N-, M- and L-pieces of the dices, mentioned above, take the form of a natural number and may selectively include any number provided that the natural number falls in the relationship expressed as N<M≦L.

Subsequently, the gaming machine 1 makes comparison between the dice-numbers of X-pieces of dices of the gaming machine 1 and the dice-numbers of L-pieces of the dices of the player. Among the spots of the X-pieces of dices on the site of the gaming machine 1 and the spots of the L-pieces of dices on the site of the player, if the spots of any X-pieces of dices match each other, then, determination is made that the player clears the relevant stage upon which the player is permitted to go to a subsequent stage.

Hereunder, while the presently filed embodiment is described in conjunction with a configuration wherein the number of dices of the gaming machine 1 includes any of two (N=2) to four pieces (M=4) and the number of dices of the player includes five pieces (L=5), the present invention is not limited to such numbers of pieces in determination.

FIG. 21 is a functional block diagram showing an exemplary structure of the stage information generator (second numeric value selection device) 403 in the presently filed embodiment. With the example shown in this Figure, the stage information generator 403 is comprised of a generation management device 403A and a determination device 403B. The generation management device 403A acquires a plurality of random number values from the sampling circuit 36 via the main controller 401 depending on the number of pieces of CPU-side dice for each stage determined by the determination device 403B and generates stage information including the resulting random number values, stored as CPU-side dice-numbers (second numeric values), for storage in the stage information storage device 410. The determination device 403B determines the number of pieces of CPU-side dice for each stage upon lottery for notification to the generation management device 403A.

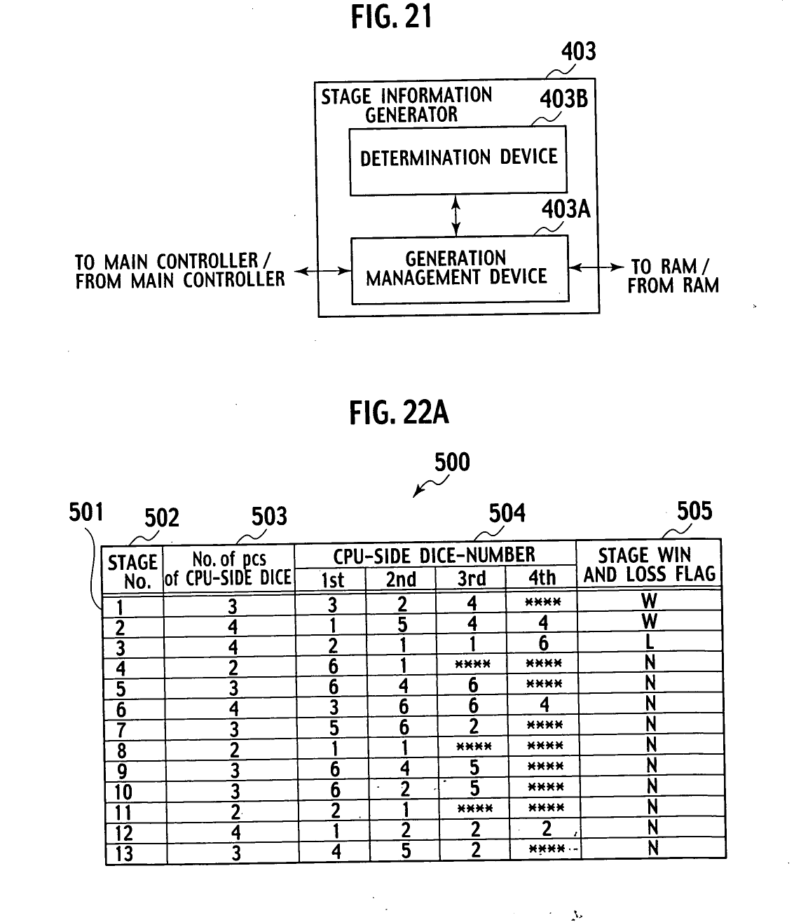

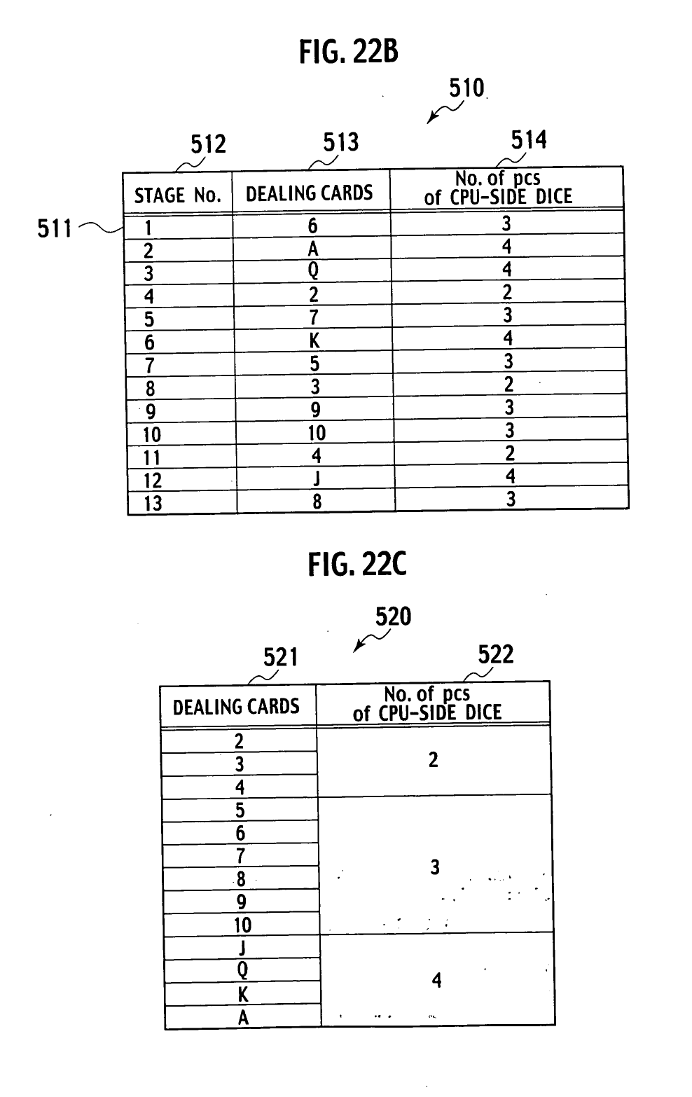

FIG. 22A shows an exemplary data structure of stage information for the second embodiment. With the example shown in this Figure, stage information 500 includes a record 501 for each stage of one game. The record 501 is comprised of a field 503 for storing the number of pieces of CPU-side dice, a CPU-side dice-number field (second storage device) 504 for storing the number of CPU-side dice-numbers depending on the numbers stored in the field 503, and a stage win and loss flag field 505 that stores a stage win and loss fag representing a win and loss status of the relevant stage. Also, since the presently filed embodiment takes the form of a struture where the number of dices on the site of the gaming machine includes two to four pieces, the field 502 is configured to include two to four CPU-side dice-numbers. Moreover, since the number of stages in one game of the presently filed embodiment includes thirteen stages, stage information 500 has thirteen records 501.

The field 503, owned by stage information 500, has values that are determined by the determination device 403B. The determined values are written in stage information 500 by the generation management device 403A.

FIG. 22B shows an example of intermediate data for determining the CPU-side dice number to be generated by the determination device 403B. With this example, the determination device 403B determines the number of pieces of CPU-side dice by dealing (allocating) playing cards and thirteen cards from A (Ace) to K (King) on each stage.

Intermediate data 510 includes a record 511 for each stage. The record 511 is comprised of a stage number field 512, in which a stage number is stored, a dealing card field 513, storing therein a value of a card given on each stage, and a field 514 that stores a number of pieces of CPU-side dice associated with the dealing card field 513.

First, the determination device 403B operates such that thirteen pieces of card numbers from “A” (Ace) to “K” (King), corresponding to playing cards, are randomly numbered from first to thirteenth pieces. This numbering may be performed upon causing the determination device 403B to internally generate random number values or causing random number values, acquired from the sampling circuit 36, to be used.

Then, the determination device 403B allows the thirteen card numbers from “A” (Ace) to “K” (King) to be stored in the dealing card field 513 in such an order as described above. Subsequently, the determination device 403B makes comparison between the card number, stored in the dealing card field 513, and a table 520, described below, and allows a numeric value, representing the number of pieces of CPU-side dice associated with the-card number, to be stored in the field 514.

FIG. 22C shows an exemplary data structure of the table 520. The table 520, which represents data stored in the determination device 403B or the ROM 34, is comprised of a dealing card field 521, storing therein a card number indicative of a dealing card, and a field 522 for storing a number of pieces of CPU-side dice associated with the relevant card number.

With the table 520 shown as such an example, it is set such that a number of pieces of CPU-side dice is “2” for stages with card numbers from “2” to “4”; the number of pieces of CPU-side dice lies at a value of “3” for stages with the card numbers from “5” to “10”; and the number of pieces of CPU-side dice lies at a value of “4” for stages with the card numbers “J” (Jack: 11), “Q” (Queen: 12), “K” (King: 13) and “A” (Ace: 1).

The determination device 403B stores a value, indicative of the number of pieces of CPU-side dice, in the field 514 (see FIG. 22B) of intermediate data 510 upon referring to the table 520. For instance, the determination device 403B executes the operation such that if the card number, stored in the dealing card field 521 (see FIG. 22C), is “2”, then, a value of “2” is stored in the field 514, likewise, if the card number is “5”, then, a value of “3” is stored in the field 514; and if the card number is “J”, then, a value of “4” is stored in the field 514.

As the value, indicative of the dice number, is stored in the field 514, the determination device 403B allows the value, stored in the field 514, to be transferred to the generation management device 403A. The generation management device 403A allows the value, received from the field 514, to be stored intact in the field 503 of stage information 500.

Also, the present invention has no intension to be limited to a configuration wherein the field 514 of intermediate data 510 employs the card numbers, set forth above, and the present invention may also be implemented even when using any determining method provided that the number of pieces of CPU-side dice is determined in a random manner.

Description of the gaming machine 1 of the presently filed embodiment is continued.

Upon startup, the stage information generator 403 (generation management device 403A: see FIG. 21) determines the number of required random number values by referring to the values stored in the field 503 of stage information 500, requesting the main controller 401 for the required number of random number values to be provided. The main controller 401 acquires the required number of random number values from the sampling circuit 36 for delivery to the stage information generator 403 (generation management device 403A). The stage information generator 403 (generation management device 403A) allows these random number values to be stored as the CPU-side dice-numbers in the CPU-side dice-number field 504.

Further, the stage information generator 403 (generation management device 403A) allows a flag value “N”, representing that an outcome of the relevant stage is pending, to be written in the stage win and loss flag field 505. Also, according to a progress of the game, if the relevant stage is executed and the player wins, then, the flag value is written as a value “W” and, in contrast, if the player loses, the flag value is written as a value “L” for use in managing the progress of the game.

Furthermore, if the bet number is less than a predetermined value, that is, when a value, stored in the bet value storage device 409, falls in a predetermined condition (such as, for instance, a value less than 10 coins), the stay information generator 403 allows the flag value to be written as “F” (Forbidden) for given records (such as, for instance, records relevant to the stages No. 9 to No. 13). Then, the main controller 401 recognizes that the player has no capability of playing the game on the stage relevant to the record 501 whose flag value is written with “F” (Forbidden) and no stage executing operation, described below, is executed for the stage relevant to the record 501 with the flag value of “F”.

[3.2. Player-Side Dice-Number Determining Device]

With the presently filed embodiment, the player-side dice-number determination device 404 (first numeric value selection device) has a function to generate player-side information, involving player-side dice-numbers (first numeric values), to be stored. The player-side dice-number determination device 404 has the substantially same configuration as that of the first embodiment [1.4.4. Player-side Dice Determining Device] and, hence, duplicated description is herein omitted.

Even with the presently filed embodiment, player-side information as the same data structure as that shown in FIG. 6. Like in the first embodiment, the player-side dice information 600 has the five records 601 associated with the five dices, respectively. Each record is comprised of the dice code field 602 storing therein the dice numbers to be distinguished from the other dices, the player-side dice-number field (first storage device) 603, storing five pieces of player-side dice-numbers (first numeric values) forming the random number values received from the main controller 401, and the “H/T” flag field 604 that stores the flags (“HOLD/TURN”: which is referred to as “H/T” flag) representing the statuses on the holding and re-determination of the player-side dice-numbers (first numeric values). The “H/T” flag field 604 represents the field that stores any one of a flag value “H”, which means that the player-side dice-numbers (first numeric values) are to be held, and a flag value “T” that means that the player-side dice-numbers (first numeric values) are to be re-determined.

That is, even with the presently filed embodiment like the first embodiment, upon receipt of the five random number values from the main controller 401, the player-side dice-number determination device 404 allows the five random number values to be stored in the player-side dice-number field (first storage device) 603 of the five records, respectively, and the flag value “T”, indicative of the re-determination, is stored in the “H/T” flag fields 604 of all the records 601. Also, it doesn't matter if no flag value “T” is stored but the flag value “H” is stored as an initial value.

[3.3. Player-Side Dice-Number Re-Determination Device]

A function of the player-side dice-number re-determination device 405 of the presently filed embodiment is described. The gaming machine 1 of the presently filed embodiment operates like the first embodiment in a way to enable a whole of or a part of the five player-side dice-numbers (first numeric values selected by the first numeric value selection device), functioning as five player-side dice-numbers determined by the player-side dice-number determination device 404, to be selected by the player for re-determination only once. The player-side dice-number re-determination device 405 has a function to re-determine the player-side dice-numbers (first numeric values). The player-side dice-number re-determination device 405 executes the same operation as that of the first embodiment and, hence, duplicated description is herein omitted (see [1.4.5 Player-Side Dice Redetermination Device]).

[3.4. Stage Win and Loss Determination Device]

With the presently filed embodiment, the stage win and loss determination device (main controller 401) 406 also operates in the same manner as that of the first embodiment, mentioned above, such that upon receipt of a notification with the completed operation of the player-side dice-number re-determination device 405, the stage win and loss determination device 406 is started up. The stage win and loss determination device 406 executes determination to find a win and loss of the relevant stage, while making determination to find whether or not the player-side dice-numbers (first numeric values), stored in the player-side dice-number storage device 411, establish a predetermined combination. Also, since the presently filed embodiment executes the same determination method as that of the first embodiment, mentioned above, and duplicated description is herein omitted.

Further, even the presently filed embodiment uses the same dice combination table as the dice combination table 414 of the first embodiment (see FIG. 7) and, so, duplicated description is herein omitted.

[3.5. Game Outcome Processor]

Even with the presently filed embodiment, the game outcome processor 407 has the same function as that of the first embodiment, mentioned above, and uses the same payout magnification table 413 as that of the first embodiment and, so, duplicated description is herein omitted.

With that, description of the structure and function of the gaming machine 1 of the presently filed embodiment is completed.

[3.6. Exemplary Operation of Gaming Machine]

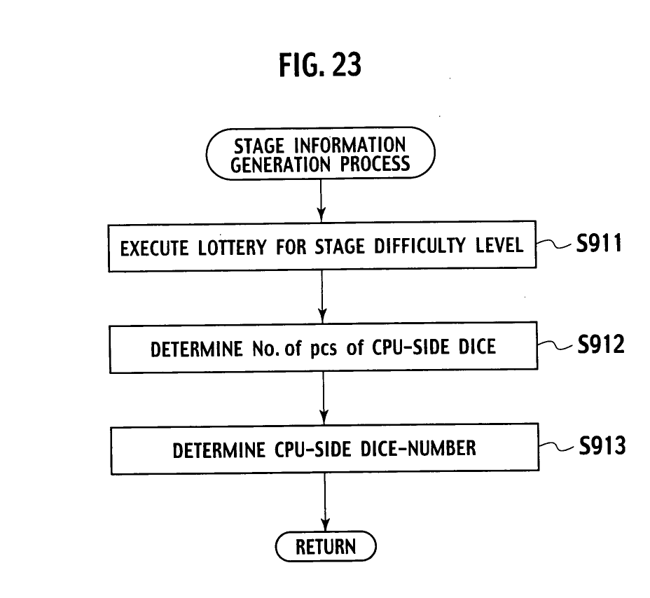

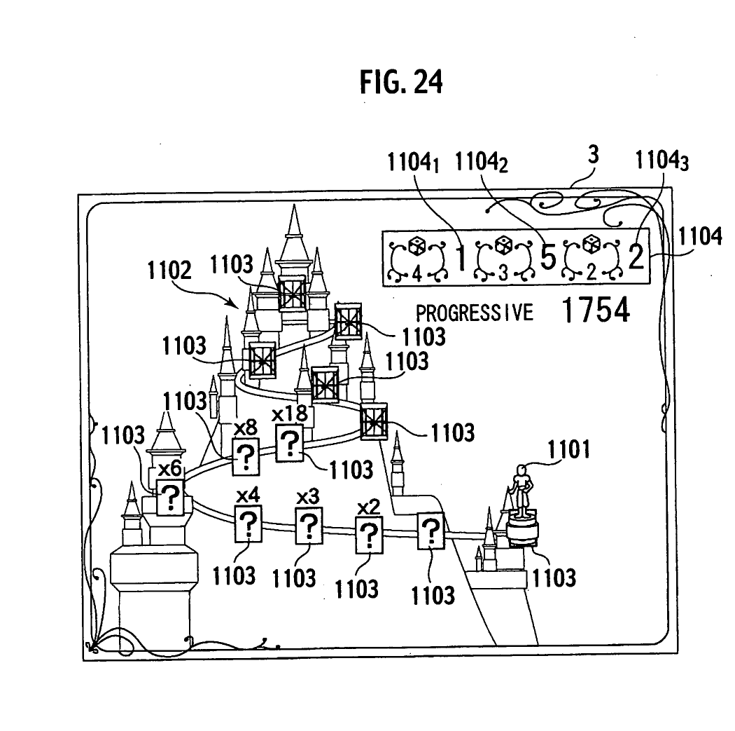

Consecutively, description is made of exemplary operation of the gaming machine 1 of the presently filed embodiment with reference to FIGS. 9, 10, PIGS. 13 to 20, FIG. 23, FIGS. 24A to 24C, FIGS. 25A and 25B and FIG. 26.

3.7. Main Operation]

The presently filed embodiment performs the same main operation as that described with reference to the first embodiment (see FIG. 9) mentioned above. Also, description related to steps S901 to S907 is herein omitted.

FIG. 24 shows an exemplary screen to be displayed over the display 3 in step S903 of the presently filed embodiment. The game in the presently filed embodiment has the same story as that of the first embodiment and, hence, duplicated description is herein omitted.

With the presently filed embodiment, a screen has an upper and right area with a feature of a display of a difficulty level display area 1104 representing a difficulty level of a game. The difficulty level display area 1104 provides a display of the number of stages, which remains unclear, for the number of pieces of CPU-side dice (the third value for the CPU-side), respectively. With this example, the difficulty level display area 1104 includes the number of pieces of CPU-side dice with four-stage numbers (referred to as four-stage numbers) 1104₁, the number of pieces of CPU-side dice with three stage numbers (referred to as three stage numbers) 1104₁, and the number of pieces of CPU-side dice with two-stage numbers (referred to as two-stage numbers) 1104₁.

With the presently filed embodiment of such a structure, a player is able to predict a difficulty level of a game in a phase from a numeric value, shown in the difficulty level display area 1104, to the clearing of the game. For instance, it may be predicted such that the greater the value of the four-stage number 1104₁ and less the value of the two-stage number 1104₃, the higher will be the difficulty level (with a lower probability for a player to win a game) and, in contrast, the less the value of the four-stage number 1104₁ and greater the value of the two-stage number 1104₃, the lower will be the difficulty level (with a higher probability for the player to win the game).

Further, the player makes it possible to predict a difficulty level of a subsequent stage. That is, among, for instance, the remaining thirteen stages, the stage number, whose the number of pieces of CPU-side dice is four, can be determined based on a value of the four-stage number 1104₁ and it becomes possible to evaluate a probability wherein when a game is caused to proceed to a subsequent stage, the subsequent stage has a high difficulty level with the the number of pieces of CPU-side dice including four pieces or, in contrast, wherein when the game proceeds to the subsequent stage from a value of the two-stage number 1104₃, the subsequent stage has a low difficulty level with the the number of pieces of CPU-side dice including two. Depending on such probabilities evaluated from the display of such a difficulty level display area 1104, the player is able to make strategic determination whether to go to the subsequent stage or not to go to the subsequent stage while choosing to receive a payout of winning coins in expectation on the subsequent game.

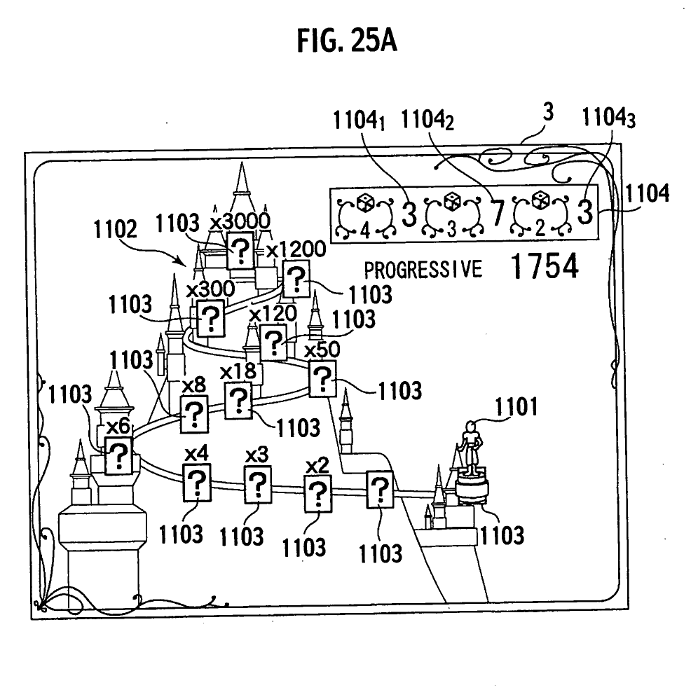

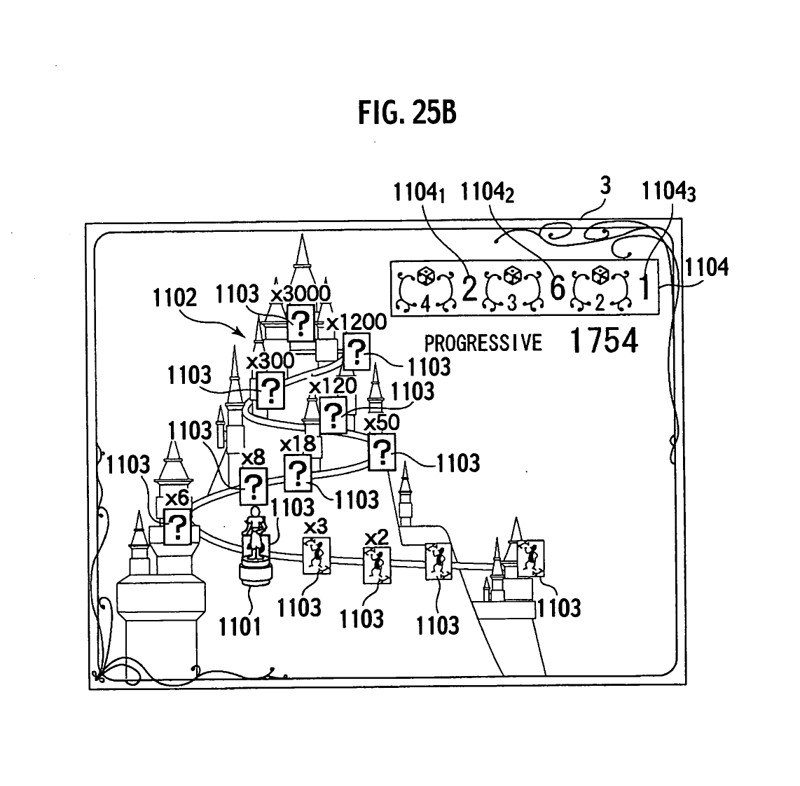

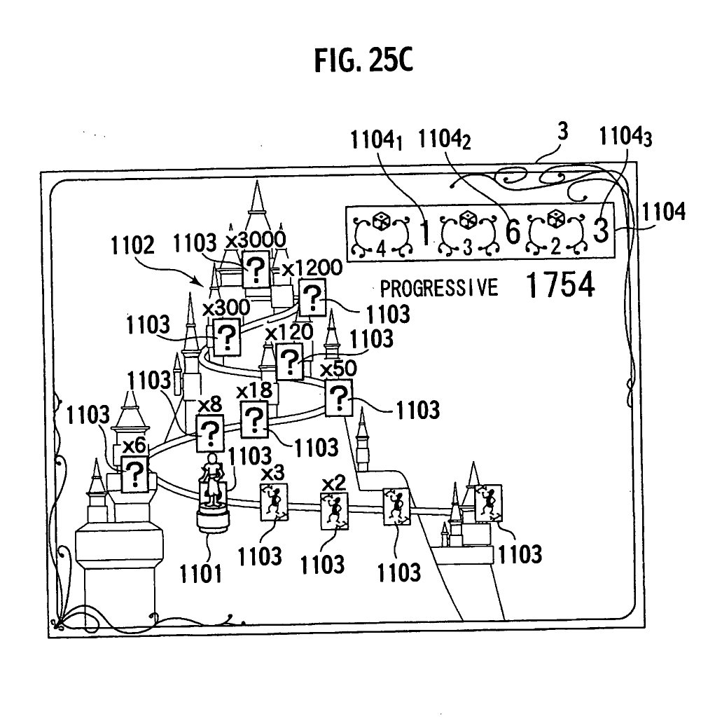

FIG. 25A shows an exemplary screen to be displayed over the display 3 in step S904 of the presently filed embodiment. Although the example of this Figure is substantially similar to the screen shown in FIG. 24, all of the room icons 1103 of the thirteen rooms are displayed in symbols (“?”) each representing a capability of challenging.

FIG. 25B shows an exemplary screen wherein the player clears the first stage to the fourth stage and goes to the fifth stage. The player character 1101 moves onto the icon 1103 of the fifth stage to inform the player with a progress of the game. Further, the icons 1103 on the first to fourth stages, which are cleared, have picture patterns that are altered from picture patterns in respective question marks to pictures patterns of respective pictures for display, thereby providing the player with a notification that these stages represent cleared stages. Moreover, the four-stage number 1104₁, the three-stage number 1104₂ and the two-stage number 1104₃ of the difficulty level display areas 1104 vary depending on the difficulty levels which have been cleared, making it possible for the player to evaluate a difficulty level of a remaining stage.

Next, FIG. 23 shows a flowchart of one example of stage information generating operation of the presently filed embodiment. Upon startup of the stage information generating operation (S905: see description of the first embodiment), the stage information generator 403 determines a difficulty level of each stage upon lottery (S911). With the presently filed embodiment, the difficulty level is determined using a method based on the dealing of playing cards.

Then, the stage information generator 403 executes a determining operation (S912) that functions as operation to determine the number of pieces of CPU-side dice for respective stages depending on a difficulty level determined for each stage.

Subsequently, the stage information generator 403 executes CPU-side dice-number determining operation to determine CPU-side dice-numbers (second numeric values) depending on the number of pieces of CPU-side dice for the respective stage determined in the determining operation (S913). Then, the stage information generator 403 completes generating stage information 500, in which the CPU-side dice-numbers and other additional requisite information are stored, which are stored in the stage information storage device 410.

With that, the stage information generating operation (S905) of the presently filed embodiment is completed, upon which control is returned to the main operation (see FIG. 9). Also, with the stage information generating operation (S905) to be executed in the train of step S903, the CPU-side dice-numbers for the first to eight stages may be determined and none of the CPU-side dice-numbers for the ninth to thirteenth stages may be determined. Also, the stage information generating operation is implemented in the same operational steps as those subsequent to step S906.

Stage Executing Operation

The succeeding stage executing operation is carried out in the same steps as those of the first embodiment (see FIGS. 10 and 13) and, hence, duplicated description is herein omitted.

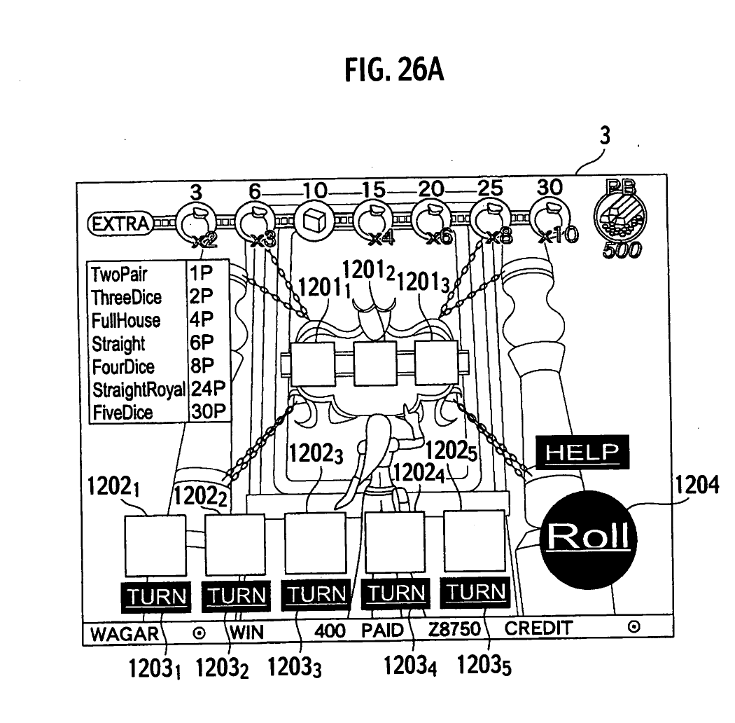

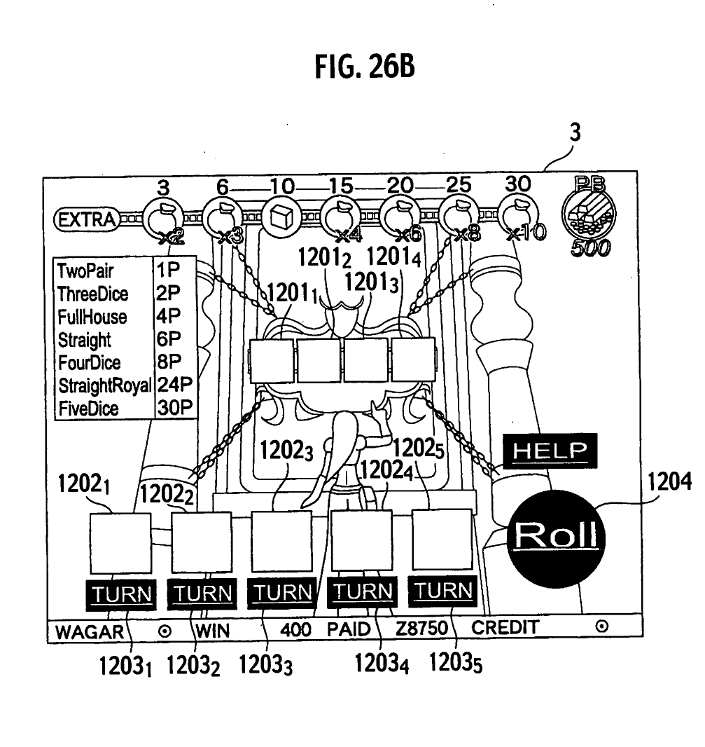

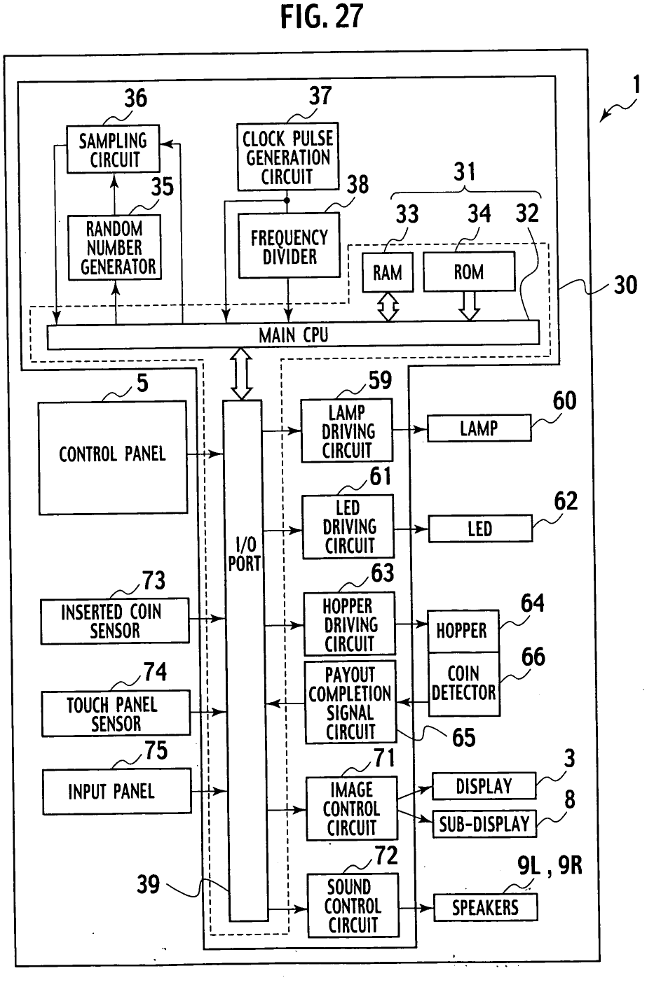

FIG. 26A shows an exemplary screen for a stage wherein the the number of pieces of CPU-side dice is three. This example differs from the exemplary screen, shown in FIG. 13, in that the screen has CPU-side dice-number display areas 1201₁, 1201₂ and 1201₃ depending on the number of pieces of CPU-side dice and has a similar structure in other respect.

Further, FIG. 26B shows an exemplary screen for a stage in which the number of pieces of CPU-side dice is four. This example differs from the exemplary screen, shown in FIG. 26A, the screen has CPU-side dice-number display areas 1201₁, 1201₂, 1201₃ and1201₄ depending an the number of pieces of CPU-side dice and has a similar structure in other respect.

Furthermore, a situation, under which the number of pieces of CPU-side dice is two in the presently filed embodiment, is similar to the screen of the first embodiment (see FIGS. 13, 15 and 16) and, so, duplicated description about other steps of the stage executing operation, shown in FIG. 10, is herein omitted. Screens, which are displayed in stages wherein the number of pieces of CPU-side dice includes three pieces or four pieces, differ from each other only in respect of the number of the CPU-side dice-number display areas 1201 and no difference exists in other respects.

Moreover, even with the second embodiment, the same re-determining operation (S1005) as that of the first embodiment, described with reference to FIGS. 17 to 20 set forth above is executed. Duplicated description is herein omitted.

With that, description of the exemplary operation of the gaming machine 1 of the second embodiment is completed.

### 4. Third Embodiment

Although the second embodiment has been described in conjunction with a structure wherein changing the number of pieces of CPU-side dice allows the setting of a difficulty level of a stage, the present invention may be implemented in a structure wherein the number of dices of a gaming machine 1 is not altered and the number of pieces of a player is altered to allow the setting of a difficulty level of a stage.

An outline of a game, to be provided by the gaming machine 1, is described below. First, the gaming machine 1 executes operation for each stage to determine either number of pieces from among P-pieces to Q-pieces to be the number of dices of the player to be used in the relevant stage (with the number of dices determined for the player assigned to be Y-pieces; provided that “Y” represents a natural number that satisfies the relationship P≦Y≦Q).

Next, the gaming machine 1 randomly determines dice-numbers of O-pieces of dices for the gaming machine 1, while causing the Y-pieces of dices for the player to be rolled for determining dice-numbers of the Y-pieces of dices of the player. Also, the numbers of pieces O, P, Q of dices, mentioned above, represent a natural number and may be possible to selectively include any number provided that the relationship O≦P<Q is established.

Then, the gaming machine 1 makes comparison between the dice-numbers of the O-pieces of dices for the machine 1 and the dice-numbers of the Y-pieces of dices for the player upon which if either one of the dice-numbers of the O-pieces of dices for the gaming machine 1 and the dice-numbers of the Y-pieces of dices for the player matches the dice-numbers of the O-pieces of dices, then, determination is made that the player clears the relevant stage, thereby permitting the player to go to a subsequent stage.

For instance, the gaming machine 1 makes determination in a random manner such that the number of pieces of dices for the gaming machine 1 is fixed to be two-pieces (=O-pieces) and the number of pieces of dices for the player is assigned to be either one of “5”, “4”, “3” (P=3 and Q=5) depending on a difficulty level of a stage. Such determination is executed by the stage information generator 403, functioning as a dice-number determination device (third numeric value selection device) and, depending on the number of dices determined by the stage information generator 403, the player-side dice-number determination device 404 determines values of the player-side dice-numbers (first numeric values) for the number of pieces depending on the number of pieces of the dices.

The presently filed embodiment operates such that the greater the number of pieces of dices for the player, the lower will be the difficulty level of the stage and, in contrast, the less the number of pieces of dices for the player, the higher will be the difficulty level of the stage.

If the player clears respective stages upon which the player clears all of the stages forming the game, then, determination is made that the player wins the game. With the player wining the game, a premium (such as a payout of coins or the like) is paid out to the player. The gaming machine 1 of the presently filed embodiment is identical to the gaming machine 1 of the second embodiment in other respects (a structure, a function and operation of the gaming machine) except for those mentioned above.

Even such a third embodiment makes it possible to provide a game in which like the first embodiment, a difficulty level can be set in a random manner for each stage so as to preclude the difficulty level from simply increasing as the stage progresses.

### 5. Fourth Embodiment

A fourth embodiment represents a gaming machine related to a combination between the second and third embodiments. That is, the gaming machine 1 of the fourth embodiment has a feature in that altering both of the numbers of pieces of dices for the gaming machine 1 and the numbers of pieces of dices for the player allows the setting of a difficulty level of each stage.

An outline of a game, to be provided by the gaming machine 1, is described below. First, the gaming machine 1 executes operation for each stage to determine either number of pieces from among N-pieces to M-pieces to be the number of dices of the gaming machine 1 to be used in the relevant stage (with the number of dices determined for the gaming machine 1 assigned to be X-pieces; provided that “X” represents a natural number that satisfies the relationship N≦X≦M). Further, the gaming machine 1 executes operation for each stage to determine either number of pieces from among P-pieces to Q-pieces to be the number of dices of the player to be used in the relevant stage (with the number of dices determined for the player assigned to be Y-pieces; provided that “Y” represents a natural number that satisfies the relationship P≦Y≦Q).

Then, the gaming machine 1 determines dice-numbers of the X-pieces of dices for the gaming machine 1, while randomly determining dice-numbers of the Y-pieces of dices for the player. Also, either one of the numbers of pieces N, M, P, Q, X, Y of the dices, mentioned above, represents a natural number and may be possible to selectively include any number provided that the relationship N<M, P<Q, X≦Y is established.

Then, the gaming machine 1 makes comparison between the dice-numbers of the X-pieces of dices for the gaming machine 1 and the dice-numbers of the Y-pieces of dices for the player upon which if either one of the dice-numbers of the X-pieces of dices for the gaming machine 1 and the dice-numbers of the Y-pieces of dices for the player matches the dice-numbers of the X-pieces of dices, then, determination is made that the player clears the relevant stage, thereby permitting the player to go to a subsequent stage.

In such a way, if the player clears respective stages upon which the player clears all of the stages forming the game, then, determination is made that the player wins the game. With the player wining the game, a premium (such as a payout of coins or the like) is paid out to the player.

The gaming machine of the presently filed embodiment is identical to the gaming machine 1 of the second embodiment in other respects (a structure, a function and operation of the gaming machine) except for those mentioned above.

With the gaming machine 1 of the presently filed embodiment, it stands that a stage, which is set to have a high difficulty level, results in a stage wherein there is a large number of dices of the gaming machine 1 and there is a small number of dices of the player whereas, in contrast, a stage, which is set to have a low difficulty level, results in a stage wherein there is a small number of dices on the side of the gaming machine 1 and there is a large number of dices of the player

The difficulty level of the stage is set in the same method as that of the second embodiment such that a difficulty level is determined by the stage information generator 403, functioning as a determination device for determing a number of pieces of dice for both of the gaming machine and player (third value selection device) and, depending on the resulting difficulty level upon determination, the number of dices for the gaming machine 1 and the number of dices for the player are determined upon which information, related to these numbers of pieces, are written in stage information 500. Moreover, like the second embodiment, the CPU-side dice-numbers (second numeric values) and the player-side dice-numbers (first numeric values) are determined by the stage information generator 403, which functions as the CPU-side dice-number determining device (second numeric value selection device) and the player-side dice-number determination device 404, respectively.

Also, the number of dices for the gaming machine 1 and the number dices for the player may have no need to be directly determined based on a difficulty level and it may be altered such that a difference, a ratio and a rate between the number of dices for the gaming machine 1 and the number of dices for the player are determined based on the difficulty level upon which the number of dices for the gaming machine 1 and the number of dices for the player are determined based on the difference, ratio and rate resulting from determinations.

Like the second embodiment, even with the gaming machine 1 of the fourth embodiment, a game can be provided to be available such that a difficulty level is set for each stage in a random manner so as to preclude the difficulty level from simply increasing as the stage progresses.

### 6. Others

(1) While the present invention has been described above with reference to the second to fourth embodiments wherein depending on the number of bet coins, the difficulty levels are selected in a way to allow a less number of stages to be provided for a beginner and entire stages to be provided for an expert, the present invention may be implemented in techniques wherein setting to increase or decrease the number of stages with a large number of dices for a CPU-side and/or setting to increase or decrease the number of stages with a less number of dices for the CPU-side; and/or setting to increase or decrease the number of stages with a large number of dices for a player-side and/or setting to increase or decrease the number of stages with a less number of dices for the player-side; whereby difficulty levels can be set for the beginner and expert, respectively.

For instance, making description of the second embodiment wherein only the CPU-side dice number is altered, fundamental difficulty levels are set to allocate “3” to the number of stages in four pieces, “7” to the number of stages in three pieces and “3” to the number of stages in two pieces and the number of stages for a large number of pieces of CPU-side dice is decreased while the number of stages for a less number of pieces of CPU-side dice is increased such that when making the setting with a low difficulty level, for instance, the difficulty levels are set to allocate “1” to the number of stages in four pieces, “7” to the number of stages in three pieces and “5” to the number of stages in two pieces.

On the contrary, when making the setting with a high difficulty level, the number of stages for a large number of pieces of CPU-side dice is increased while the number of stages for a less number of pieces of CPU-side dice is decreased the number of stages for a large number of pieces of CPU-side dice is increased and the number of stages for a less number of pieces of CPU-side dice is decreased to allocate, for instance, “5” to the number of stages in four pieces, “7” to the number of stages in three pieces and “1” to the number of stages in two pieces.

Although such difficulty levels may be conceivably set in various methods wherein a plurality of dice number tables 520 are prepared for difficulty levels to allow the setting of the difficulty levels whereas the determination device 403B is so set as to allow structures of dealing cards to be written into specified configurations such that, for instance, all of the cards from “J” to “K” are overwritten to “2”, the present invention has no intention to be limited to such methods and the present invention may be implemented in any method provided that the methods provide a capability for the number of stages to be controlled for the number of pieces of CPU-side diceor the number of pieces of player-side dice.

(2) While the second to fourth embodiments have been described with reference to the structures employing the dices, the present invention may be established even when using play equipment, having a plurality of kinds of cards or tiles, such as playing cards or Japanese playing cards in place of the dices.

(3) While the second to fourth embodiments have been described with reference to the structures wherein the CPU-side dice-numbers (second numeric values) and the player-side dice-numbers are determined for all of the first to thirteen stages prior to the beginning of the first stage after the game is started, the present invention has no intention to be limited to such structures and it doesn't matter if only the CPU-side dice-numbers and the player-side dice-numbers are determined for each stage on a case-by-case basis prior to the beginning of each stage.

(4) While the second to fourth embodiments have been described with reference to the structures wherein the number of pieces of CPU-side dice and the number of pieces of player-side dice are determined for all of the first to thirteenth stages prior to the beginning of the first stage after the game is started, the present invention has no intention to be limited to such structures and no objection exists if the number of pieces of CPU-side dice and the number of pieces of player-side dice are determined only for each stage on a case-by-case basis before a start of each stage.

One example of the second embodiment is hereinafter described. The number of stages is preliminarily determined for each of the number of pieces of the CPU-side dice on all stages. For instance, it is determined such that the number of stages is “3” for the number of pieces of the CPU-side dice with “2”, the number of stages is “7” for the number of pieces of the CPU-side dice with “3” and the number of stages is “3” for the number of pieces of the CPU-side dice with “4” upon which the number of pieces of the CPU-side dice for the first stage is determined based on random number values prior to the beginning of the first stage. Suppose that the number of pieces of the CPU-side dice for the first stage is determined to be “2”, the first stage is executed as a stage, whose the number of pieces of the CPU-side dice is “2”, and the number of pieces of the CPU-side dice for the first stage is determined upon lottery in the same manner as the preceding one before a start of a second stage. However, since one of the stages, whose the number of pieces of the CPU-side dice is “2”, is consumed in the first stage, the number of pieces of the CPU-side dice for the second stage is determined upon executing the lottery based on conditions where the number of stages is “2” (with one stage being consumed) for the number of pieces of the CPU-side dice with “2”, the number of stages is “7” (with no change) for the number of pieces of the CPU-side dice with “3” and the number of stages is “3” (with no change) for the number of pieces of the CPU-side dice with “4”.

In such a way, the present invention is established even when determining the number of pieces of the CPU-side dice and/or the number of pieces of the player-side dice before the start of each stage and a gaming machine 1, which employs a technique of determining the number of pieces of the CPU-side dice and/or the number of pieces of the player-side dice in such a way, falls in a technical scope of the present invention.

Another embodiment of the present invention is hereinafter described. Also, the same component parts as those of the previous embodiments bear like reference numerals and duplicated description is herein omitted.

### 7. Fifth Embodiment

[7.1. Outline of Game to be Provided by Gaming Machine]

As a feature of a gaming machine 1 of the presently filed embodiment, in providing the games described with reference to the first to the fourth embodiments, the number of stages, involved in a game, is determined depending on the number of coins bet by a player at a start of the game, while determining the presence of or absence of a so-called Jackpot to be executed in parallel to the game.

[7.2. Exemplary External Structure of Gaming Machine]

The gaming machine 1 of the presently filed embodiment has the same exterior appearance as that of the gaming machine shown in FIG. 1, set forth above, and, hence, duplicated description is herein omitted (see [1.2. Exemplary External Structure of Gaming Machine]).

[7.3. Exemplary Internal Structure of Gaming Machine]

The presently filed embodiment differs from the gaming machines 1 of the first to fourth embodiments, set forth above, in respect of the internal structure (see FIG. 3) in that an input panel (an input device) 75, described below, is connected to a gaming-machine substrate 30. Other structures have been already described above and, hence, duplicated description is herein omitted.

The input panel 75, functioning as an input device provided with a plurality of input keys and buttons, is mounted inside the cabinet 2 to be used for inputting Jackpot startup number of bets that conditions to allow the gaming machine 1 to mainly execute the lottery for the Jackpot. The main CPU 31 allows the Jackpot startup number of bets, inputted from the input panel 75, to be stored in a Jackpot (JP) startup storage device 418 of the RAM 33. With the presently filed embodiment, the Jackpot startup number of bets is comprised of two values including a low limit value and an upper limit value. For instance, suppose that the input panel 75 is depressed to input the lower limit value of “10” and the upper limit value of “30”. In this case, if the number of coins, bet by a player at a start of a game, is involved in any of a value ranging from 10 to 30 pieces, then, the player gets a right to receive the lottery for the Jackpot for executing the lottery for the Jackpot during the payout of the coins.

Also, it doesn't matter if only the lower limit is determined with no limitation applied to the upper limit. Moreover, if the max number of bets (such as, for instance, “5”) of a normal game, which is not a Jackpot is set, it doesn't matter if a value (such as, for instance, “10”) exceeding the max number of bets is set as the upper limit value of the Jackpot startup number of bets. In this case, the number of coins with an extent exceeding the max number of bets may be consumed for simply getting the right for the drawing of the Jackpot with no adverse affect on a normal payout magnification rate.

[7.4. Function of Gaming Machine]

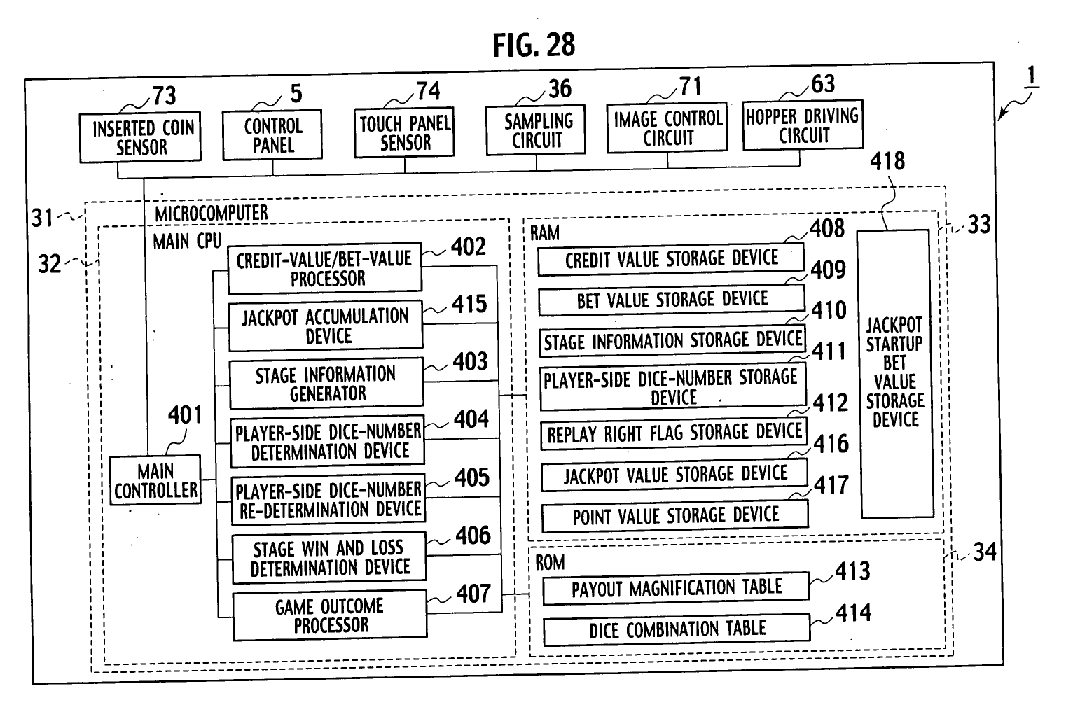

As will be understood from comparison between the functional block diagram (see FIG. 28) of the presently filed embodiment and that of FIG. 4 set forth above, the gaming machine 1 of the presently filed embodiment differs from the first embodiment, shown in FIG. 4, in that a Jackpot accumulation device 415, a Jackpot value storage device 416, a point storage device 417 and a Jackpot startup bet value storage device 418 are further provided. The gaming machine 1 of the presently filed embodiment is similar to the structure of FIG. 4 in other respects and, hence, duplicated description is herein omitted (see [1.4. Function of Gaming Machine]).

[7.5. Jackpot Accumulation Device]

Now, description is made of an area related to the Jackpot that forms a feature of the presently filed embodiment.

The Jackpot accumulation device 415, functioning as a Jackpot accumulation device, has a function in that each time the credit-value/bet-value processor 40 allows the bet value storage device to execute adding operation, a percentage of the added component is added to a value stored in the Jackpot value storage device 416, described below, for storage therein. For instance, suppose that in cases where the value, currently stored in the Jackpot value storage device 416, lies in a value of “1200.8”, a player bets a value equivalent to ten coins to make an attempt to play a game. When this takes place, the credit-value/bet-value processor 402 allows a value of “10” to be added to the value stored in the bet value storage device 409. The credit-value/bet-value processor 402 allows the main controller 410 to provide the Jackpot accumulation device 415 with a notification of the value of “10” to be added. The Jackpot accumulation device 415 calculates a predetermined ratio (supposed to be 100%) of the value of “10” to be added, with the resulting value being added to the value of “1200.8” to be stored to provide a new Jackpot value of “1201.8” that is stored in the Jackpot value storage device 416.

Also, a whole of or a part of the Jackpot value, stored in the Jackpot value storage device 416, represents a value corresponding to the number of payout coins when a player wins the Jackpot.

[7.6. Stage Information Generator]

The stage information generator 403, functioning as the CPU-side dice-number determination device (second numeric value selection device), has a function to generate stage information including a CPU-side dice-number. Such a function is identical to those of the first and second embodiments and, hence, detailed description of the same is herein omitted. Moreover, the presently filed embodiment employs the same information as those of the data structural example (see FIG. 5) of stage information, the data structural example (see FIG. 6) of player-side information and the dice combination table (see FIG. 7) of the first embodiment mentioned above and, hence, duplicated description is herein omitted (see [1.4.3. Stage Information Generator], [1.4.4. Player-side Dice-Number Determining Device], [1.4.5. Player-side Dice-Number Re-determination Device],[1.4.6. Stage Win and Loss Determination Device] and [1.4.7. Game Outcome Processor]).

With the presently filed embodiment, a slight difference exists in a function of the stage win and loss determination device. That is, with the presently filed embodiment, it is supposed that a premium, associated with the relevant combination, represents a point value for obtaining a right to receive the lottery for the Jackpot. The player handles the stage to make a combination for thereby enabling a point value to be accumulated. If the accumulated point value reaches a predetermined value, the player gets the right of the lottery for the Jackpot and the player executes the lottery for the Jackpot under a predetermined condition like at the end of the game. With the occurrence of the winning, the player is able to receive a payout of the number of coins corresponding to a value stored in the Jackpot value storage device 416.

Further, the presently filed embodiment slightly differs from the first embodiment in the game outcome processor in points described below. That is, upon startup, the game outcome processor 407 executes a payout operation referring to the payout magnification table 413 (see FIG. 8 of the first embodiment). Moreover, if the number of bets remains under a predetermined condition and a jackpot startup operation, described below, is executed, the lottery for the Jackpot is executed upon which if an outcome of the lottery results in the winning, the operation is executed to pay out the number of coins equivalent to a value corresponding to the Jackpot value stored in the point value storage device 417. Also, even with the presently filed embodiment, the payout magnification table 413 is used in the same way as that of the first embodiment and, hence, duplicated description is herein omitted.

Referring to FIG. 28, description is continued of a function of the microcomputer 31 of the presently filed embodiment. With the presently filed embodiment, the RAM 33 functions as a Jackpot startup bet value storage device 418. The Jackpot startup bet value storage device 418 stores a Jackpot startup number of bets, representing information related to the number of bets that forms a condition under which the drawing of the Jackpot is executed. The Jackpot startup number of bets is inputted using the input panel 75 and, with the presently filed embodiment, a set of two values on a lower limit value and an upper limit value are assigned to be the Jackpot startup number of bets.

With the above, descriptions of the structure and function of the gaming machine 1 are completed.

[7.7. Exemplary Operation of Gaming Machine]

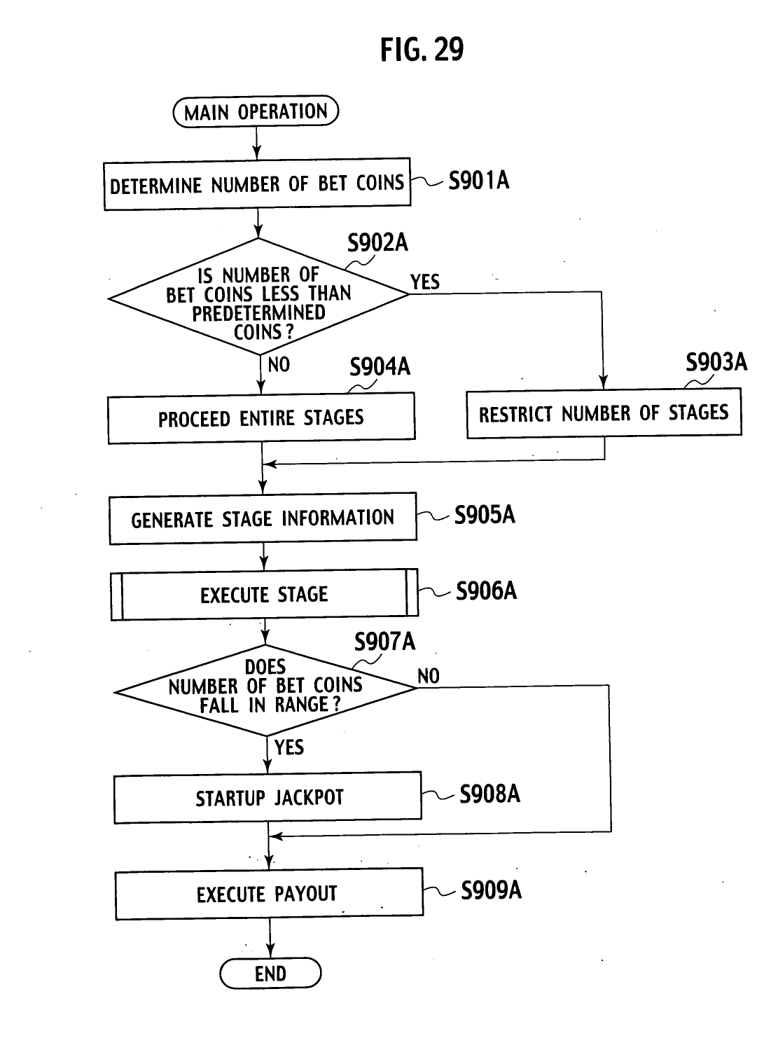

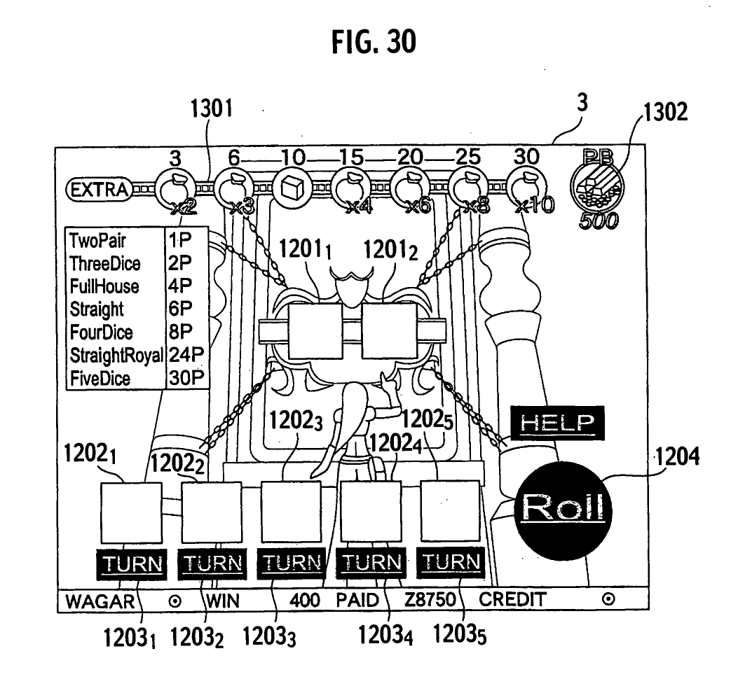

Consecutively, exemplary operation of the gaming machine 1, mentioned above, is described with reference to FIG. 29. A main operation of the presently filed embodiment, shown in FIG. 29, differs from the main operation (see FIG. 9) of the first embodiment, mentioned above, in respect of operations for a BET number (S907A) and Jackpot startup operation (S908A) to be executed. Also, even the presently filed embodiment has the same stage executing operation as that of the first embodiment (see FIG. 10).

[7.8. Main Operation]

With the presently filed embodiment, steps S901A to S906A of the main operation are identical to steps S901 to S906 of the first embodiment, mentioned above, and, hence, description is herein made of only differing steps. Further, a screen, to be displayed over the gaming machine 1, is similar to that of the first embodiment (see FIGS. 11 and 12).

As the stage executing own is started (S905A), the m CPU 32 (main controller 401) executes stage initial screen display operation for display of a screen representing a user interface for a player to execute a stage (S1001). FIG. 30 shows an exemplary screen to be displayed in stage initial screen display operation.

Further, the screen has an upper area provided with a point value gauge 1301 by which a player is indicated with the degree of point value stored in the point value storage device 417 forming one feature of the presently filed embodiment. The point value gauge 1301 is shown in a status under which it extends rightward in the screen as the point value increases. If the point value reaches a predetermined value available for the player to win the right for executing the Jackpot, an icon 1302, displaying the winning on the right of the lottery for the Jackpot, is brightly displayed, thereby informing the player with the winning of the right for executing the lottery for the Jackpot.

Hereunder, description is made of operation related to the Jackpot that constitutes a feature of the present invention. As the stage executing operation is completed, then, the operation is restored to the main operation (see FIG. 29). Upon restoring the operation to the main operation, the main CPU 32 (game outcome processor 407) determines whether or not the number of bets, stored in the bet value storage device 409, falls within a range indicated by a limit value and an upper limit value stored in the Jackpot startup bet value storage device 418 (S907A).

If determination is made that the number of bets, stored in the bet value storage device 409, falls within the range mentioned above (with “Yes” in S907A), the main CPU 32 (main controller 401) executes Jackpot startup operation commanding the game outcome processor 407 to execute the Jackpot lottery (S908A). The Jackpot startup operation represents operation to allow a Jackpot startup flag to be written in the RAM 33. Subsequently, if the flag is written, then, the main CPU 32 (game outcome processor 407) executes the Jackpot drawing referring to the flag.

On the contrary, during determination in step S907A, if the number of bets, stored in the bet value storage device 409, falls within the range set forth above (with “No” in step S907A), the main CPU 32 (main controller 401) does not execute the Jackpot startup operation and shifts to the payout operation (S909A). Consequently, in subsequent payout operation (S909A), no Jackpot lottery operation is executed.

Upon completing steps S907A and S908A, the main CPU 32 executes the payout operation (S909A). That is, the main CPU 32 (game outcome processor 407) executes the operation referring to the payout magnification table 413 to allow the number of payout coins to the player depending on the game outcome.

Describing a concrete example of the payout operation, the main CPU 32 (game outcome processor 407) calculates the number of payout coins or a payout credit value referring to the content of the stage wind and loss flag field 504 of the stage information storage device 500 (see FIG 5.), the number of bets stored in the bet value storage device 409 and the payout magnification table 413. The resulting number of payout coins or payout credit value is notified to the main controller 401. The main controller 401 outputs a drive command to the hopper driving circuit 63, depending on the resulting number of payout coins or payout credit value, or allows the payout coin number or payout credit number to be added to the value stored in the credit value storage device 408. Such operations result in a capability for the player to receive the payout depending on the game outcome.

Further, if the Jackpot startup lottery (S908A) is executed, the main CPU 32 (game outcome processor 407) refers to the value, stored in the point value storage device 417 at the end of the game, in a subsequent stage and if the resulting value exceeds a predetermined value, then, the Jackpot lottery is executed. As a result of the lottery outcome, if the winning occurs, then, the main CPU 32 (game outcome processor 407) allows the number of coins, amounting to a whole of or a part of the value stored in the Jackpot value storage device 416, to be paid out to the player.

With the above, description of the main operation is completed.

As the main operation is completed, this results in a completion of one game. The gaming machine 1 is restored to a status in step S901A again at which time the next bet from the player is waited to prepare for the beginning of a subsequent game.

With the above, description of the exemplary operation of the gaming machine 1 is completed.

### 8. Other

(1) With the presently filed embodiment, it may be altered such that the number of dices for the CPU is altered upon selection of the player at a start of a game. Although it stands that the greater the difference between the number of pieces of CPU-side dice and number of pieces of player-side dice, the lower will be the difficulty level of the game whereas, in contrast, the less the difference between the number of dices for the CPU and the number of dices for the player, the higher will be the difficulty level of the game, the player is able to enjoy a game with an appropriate difficulty level depending on skills of the player.

(2) Although the presently filed embodiment has been described in conjunction with the dices, the present invention may be established even when employing play equipment composed of a plurality of kinds of cards and piles, such as playing cards, Japanese playing cards and mah-jongg piles, in place of the dices.

(3) In another alternative, the stages may be arranged to have difficulty levels, respectively, and it may be set such that as the number of stages advances, the difficulty level increases. Such a setting may be made such that if the number of bets is less than a predetermined number, the player is enabled to play a game with a low difficulty level only in first half thereof and if the number of bets exceeds the predetermined number, the player is enabled to play the game throughout entire stages.

(4) Although the presently filed embodiment has been described with reference to a structure wherein the CPU-side dice-numbers are determined for all of the first to thirteen stages before the first stage is begun at a start of the game, the present invention is not limited to such a structure and it doesn't matter if only the CPU-side dice-number is decided for a stage on a case-by-case basis before the relevant stage is started.

Now, a gaming machine of another embodiment according to the present invention is described below in detail with reference to the accompanying drawings. Also, the same or equivalent component parts bear like component parts and duplicated description is herein omitted.

### 9. Sixth Embodiment

[9.1. Gaming Machine]

The presently filed embodiment, employing a gaming machine 1 with the same external appearance as that of the fifth embodiment mentioned above, operates such that the number of stages, contained in a game, are determined depending on the number of bets made by a player at a start of a game while determining the presence of or absence of the occurrence of a so-called Jackpot to be executed in parallel with the game. Hereunder, duplicated description is omitted with description being given to a point different from the embodiments set forth above (see [1.2. Exemplary External Structure of Gaming Machine] and [1.3. Exemplary Internal Structure of Gaming Machine])

[9.3. Function of Gaming Machine]

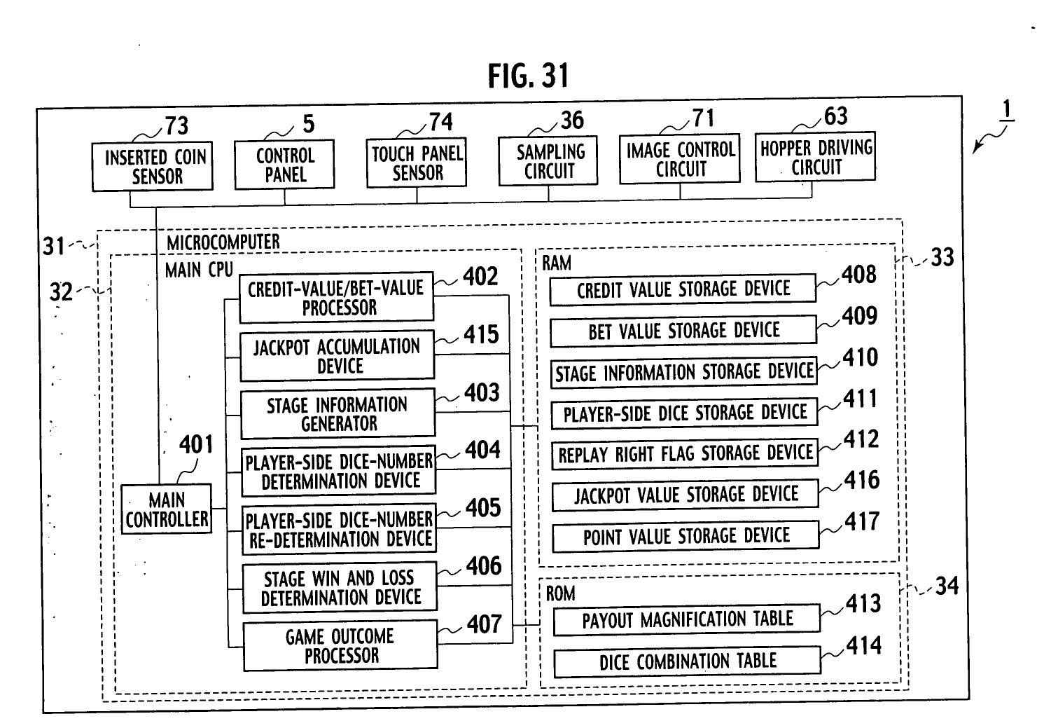

As will be understood from comparison between the structure of FIG. 31 and that of FIG. 2a, in contrast to the fifth embodiment, no Jackpot startup bet value storage device 418 is provided in the presently filed embodiment. Other component parts have been already discussed and, hence, duplicated description is herein omitted see [7.4. Function of Gaming Machine] and [7.5. Jackpot Accumulation Device]).

[9.4. Stage Information Generator]

The stage information generator 403, functioning as a CPU-side dice-number determination device (second numeric value selection device), has a function to generate stage information involving a CPU-side dice-number. Such a function is identical to those of the first and second embodiments, set forth above, and hence, detailed description of the same is herein omitted. Further, since the exemplary structure of stage information (see FIG. 5), exemplary data structure of player-side dice information 600 (see FIG. 6) and the dice combination table (see FIG. 7) for use in the presently filed embodiment are also similar to those of the first embodiment, mentioned above, and, hence, duplicated description is herein omitted (see [1.4.3. Stage Information Generator], [1.4.4. Player-side Dice-Number Determining Device], [1.4.5. Player-side Dice-Number Re-determination Device], [1.4.6. Stage Win and Loss Determination Device] and [1.4.7. Game Outcome Processor]).

[9.5. Exemplary Operation of Gaming Machine]

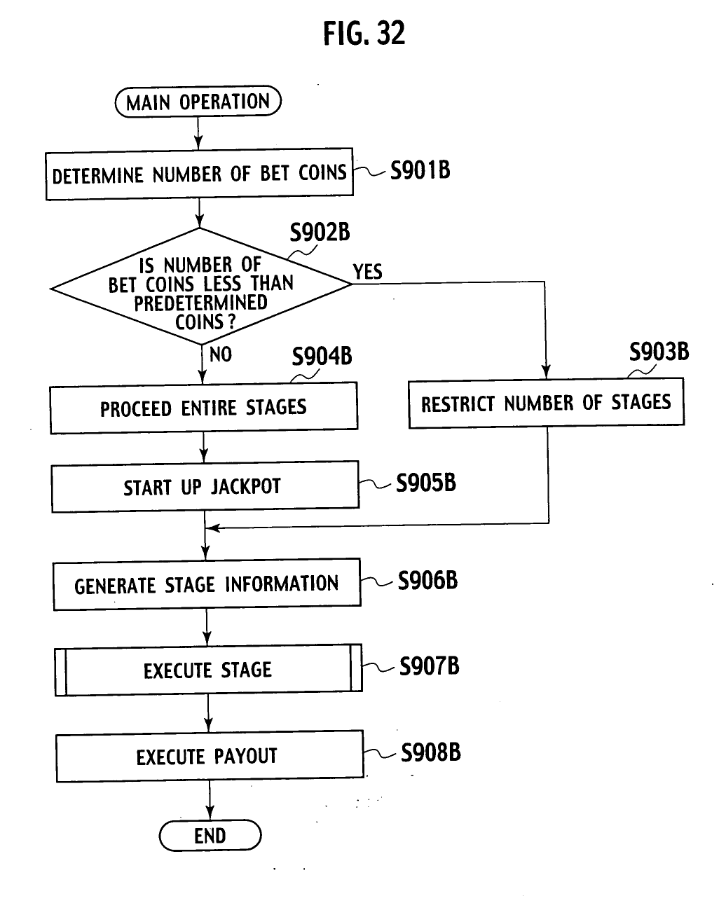

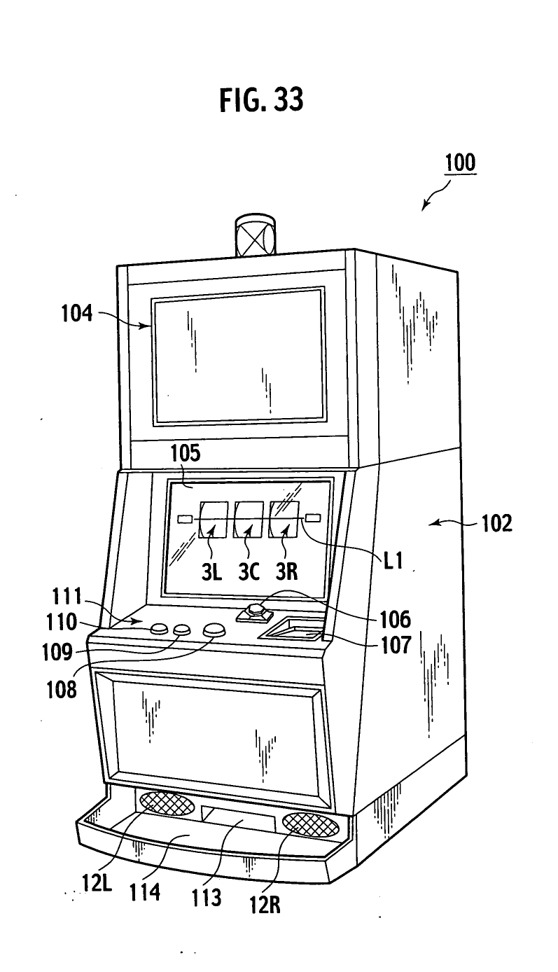

Consecutively, exemplary operation of the gaming machine 1 of the presently filed embodiment is described with reference to FIG. 32. As will be understood from comparison between the flowchart of FIG. 32 and those of FIGS. 9 and 29, the operation (S905B), related to the Jackpot, is executed in the presently filed embodiment at timing between the entire stage operation (S904B) and the stage information generating operation (S906B). Steps S901B to S904B are identical to the operations (steps S901 to 903) of the first embodiment and, hence, duplicated description is herein omitted. Also, the presently filed embodiment has the same game screens as those of FIGS. 11 to 20 and that of FIG. 30 of the fifth embodiment and, hence, duplicated description is herein omitted.

[9.6. Main Operation]

With the presently filed embodiment set forth above, if the number of bets stored in the bet value storage device 409 exceeds a predetermined number (with “No” in step S902B), the main CPU 32 (main controller) 401) executes the Jackpot startup operation commanding the game outcome processor 407 to execute the Jackpot lottery at the end of a game (S905B). The main CPU 32 (game outcome processor 407) responds to such a command and, subsequently, refers to a value stored in the point value storage device 417 whereby when the value exceeds a predetermined value, the main CPU 32 executes the Jackpot drawing. If the Jackpot lottery is executed with the resultant outcome with the occurrence of the winning, the main CPU 32 (game outcome processor 407) operates to pay out the number of coins, amounting to a whole of or a part of the value stored in the Jackpot value storage device 416, to the player. Succeeding operation from stage information generating operation to the payout operation (S906B to S908B) have been already described above and, hence, description of the same is herein omitted.

With the above, description of the exemplary operation of the gaming machine 1 is completed.

### 10. Others

(1) With the presently filed embodiment, the number of pieces of CPU-side dice may be altered upon selection of a player at a start of a game. It stands that the greater the difference between the number of pieces of CPU-side dice and the number of pieces of player-side dice, the higher will be the difficulty level of the game, making it possible for the player to enjoy a game with an appropriate difficulty level depending on skills of the player.

(2) With the presently filed embodiment, the present invention may be established even when employing play equipment composed of a plurality of kinds of cards and piles, such as playing cards, Japanese playing cards and mah-jongg piles, in place of the dices.

(3) The stages are set to have difficulty levels, respectively, and it may be set such that as the number of stages advances, the difficulty level increases. Such a setting may be made such that if the number of bets is less than a predetermined number, the player is enabled to play a game with a low difficulty level only in first half thereof and if the number of bets exceeds the predetermined number, the player is enabled to play the game throughout entire stages.

(4) Although the number of bets is less than a predetermined number (with “Yes” in step S902), the difficulty level of the game per se is made easy (see FIG. 11) to the extent equivalent to a decrease in the number of stages until the number of bets exceeds the predetermined number (with “No” in S902), it may be set such that no progressive odds (Jackpot value) occurs.

(5) Although the presently filed embodiment has been described with reference to a structure wherein the CPU-side dice-numbers are determined for all of the first to thirteen stages before the first stage is commenced at a start of the game, the present invention has no intention to be limited to such a structure and it doesn't matter if only the CPU-side dice-number is decided for a stage before the relevant stage is started.

With the present invention described above, it becomes possible to provide a game that is simple while providing a strategic characteristic. Further, according to the present invention, it becomes possible to provide a game available for a difficulty level to be set for each stage in random manner in a way to prevent the difficulty level from simply increasing as the stage proceeds. Moreover, the present invention makes it possible to provide a gaming machine that is able to suitably alter a bet condition needed for the occurrence of the winning on the Jackpot while enabling a player to enjoy strategically selecting a number of bets. Additionally, the present invention makes it possible to allow the difficulty level of the game to vary depending on the number of bets for permitting the player to strategically determine the number of bets for thereby providing a simple game with an increase in entertaining and exciting value.

### 11. Seventh Embodiment

Hereunder, the seventh embodiment of the present invention is described. In this embodiment, the present invention mentioned above is applied to a slot machine.

As shown in the slot machine 100 as the gaming machine 1 of this embodiment includes an upper display 104 and a lower display 105 that are placed in front of a cabinet 102, respectively. The lower display 105 is disposed in a substantially central area between a top and a bottom of the cabinet 102. Disposed in an inside of the cabinet 102 in association with the lower display 105 are three mechanical reels 3L, 3C, 3R that rotatably provided along the left side through the right side of the cabinet 102. In the slot machine 100, with symbols formed on the reels 3L, 3C, 3R are stopped on a pay-line L1 corresponding to the predetermined winning combination, the predetermined numbers of coins are paid out from a payout opening 113 to a receiver 114. Further, on a control panel 106, a spin switch 108 to start rotation of the reels 37, 3C, 3R, a 1-BET switch 109 to credit one coin, a Maximum-BET switch 109 to credit maximum numbers of coins are provided, respectively.

Internal Structure of Slot Machine

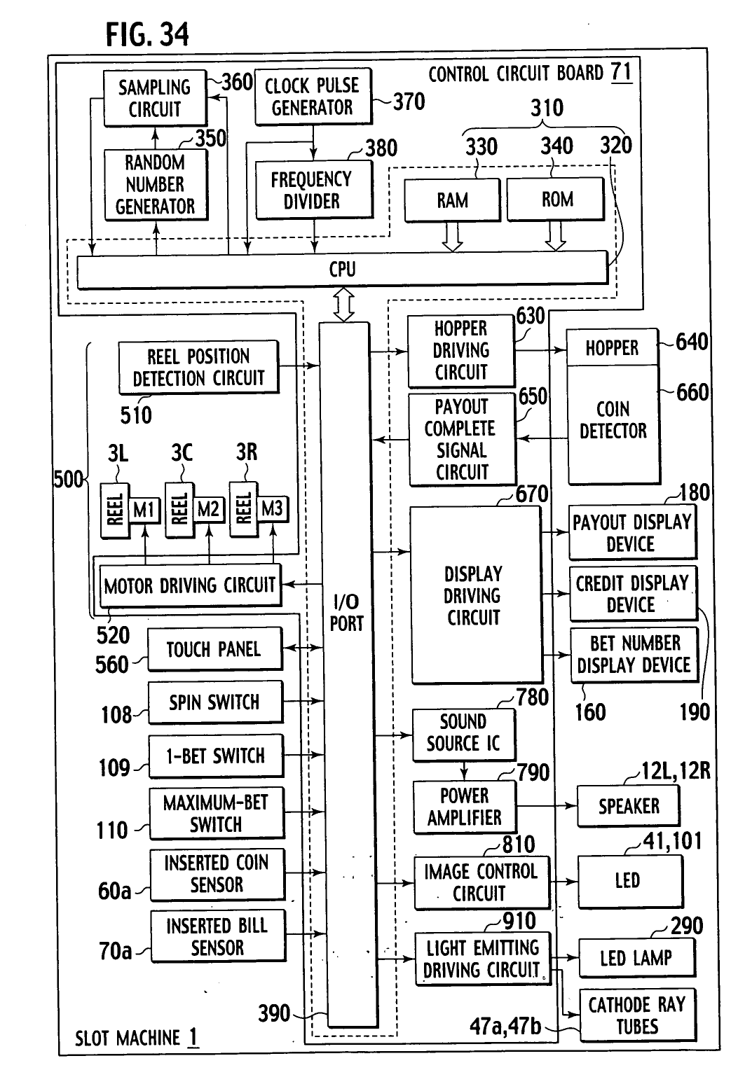

With reference to FIG. 34, the slot machine 100 is comprised of a control circuit board 710 including a microcomputer 310, a random number generator 350, a sampling circuit 360, a clock pulse generator 370 and a frequency divider 380, a hopper driving circuit 630, a payout complete signal circuit 650, a display driving circuit 670, a sound source 780, a power amplifier 790, an image control circuit and a light emitting driving circuit 910.

The microcomputer 310 includes a CPU (Central Processing Unit) 320, a RAM (Random Access Memory) 330 and a ROM (Read Only Memory) 340. The CPU 320 operates in accordance with programs stored in the ROM 340 while sending signals with the other component parts for thereby achieving control operations of the slot machine 100 as a whole. The RAM 330 stores therein data and programs, to be used for the CPU 320 to operate, which includes, for instance, random numbers subjected to sampling by the sampling circuit 360 (described below) and temporarily stored after a game has been started, code numbers of the reels 3L, 3C, 3R and symbol numbers. Also, the ROM 340 stores therein programs to be executed by the CPU 320, and lasting data.

The random number generator 350 operates in accordance with a command from the CPU 320 to generate random numbers within a certain definite range. The sampling circuit 360 responds to the command from the CPU 320 to extract an arbitrary random number from among the random numbers generated by the random number generator 350, thereafter the extracted random number is inputted to the CPU 320. The clock pulse generator 370 generates reference clock pulses, for operating the CPU 320, which are divided by the frequency divider 38 at a fixed frequency to provide a signal that is inputted to the CPU 320.

Further, connected to the control circuit board 710 is a reel driving circuit 500. The reel driving circuit 500 is comprised of a red position detecting circuit 510 that detects respective positions of the reels 3L, 3C, 3R, and a motor driving circuit 520 from which drive signals are applied to motors M1, M2, M3 by which the reels 3L, 3C, 3R are rotated, respectively. Upon receipt of the drive signals delivered from the motor driving circuit 520, the motors M1, M2, M3 are operated thereby rotating the reels 3L, 3C, 3R. In addition, the spin switch 108, the 1-BET switch 109, the Maximum-BET switch 110, an inserted coin sensor 6a and an inserted bill sensor 7a are connected to the control circuit board 710 to receive signals therefrom, respectively.

The hopper driving circuit 630 drives a hopper 640 in accordance with the control of the CPU 320 to allow the hopper 640 to execute payout operation such that the coins are paid out from the payout opening 130. The payout complete signal circuit 650 is applied with coin count data from the associated coin detector 660 and when a coin count value reaches a preset coin count value, the payout completion signal circuit 650 applies the CPU 320 with a signal giving notification that the payout of coins has been completed. The coin detector 660 measures a number of coins paid out through the hopper 640, with measured coin count data being inputted to the payout complete signal circuit 650. The display driving circuit 670 inputs data to the payout completion signal circuit 650. The display driving circuit 670 controls display operations of respective display devices (a BET number display device 16, a payout display device 180 and a credit display device 190).

Further, upon the sound source 780 receives a command from the CPU 320, the sound source 780 produces a sound control signal with a sound effect to control the speaker 12L, 12R to outputs the sound effect. That is, upon receipt of the sound control signal with the sound effect from the sound source 780, the power amplifier 790 amplifies the sound effect so that the sound effect is produced from the speakers 12L, 12R. By these configurations, various sound effects stored in the sound source are able to output from the speakers 12L, 12R, and with such sound effects with the visual effects, a various sound-visual rich game can be obtained.

Furthermore, connected to the CPU 320 is a touch panel 560. The touch panel 560 is provided to cover a surface of the protection glass 420 in front of the lower display 105. The image control circuit 81 controls the liquid crystal display devices 410,101, respectively,

The light emitting driving circuit 910 outputs drive signals depending on commands from the CPU 320 to turn on the LED 290 and the cathode ray tubes 47a, 47b for emitting lights.

Operational of Slot Machine

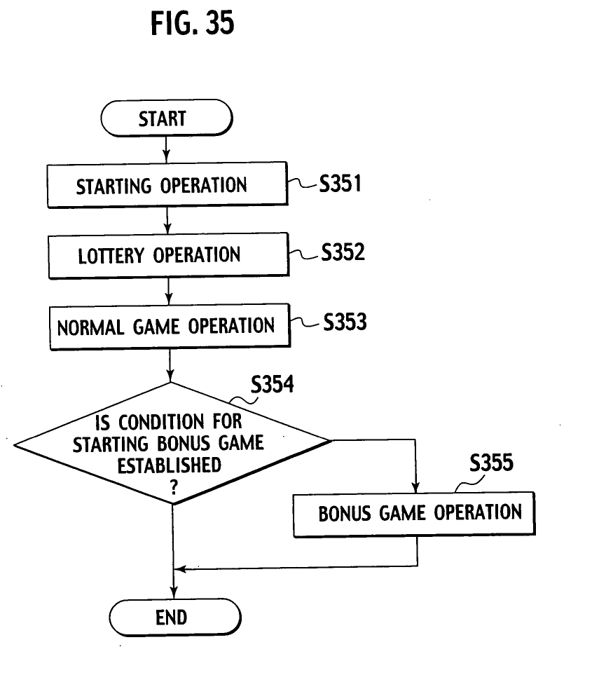

An example of operation of the slot machine is described with reference to FIG. 35.

The slot machine 100 is configured to execute a normal game and a bonus game (such as a game shown in FIG. 11). As shown in FIG. 35, when a main operation of the slot machine 100 is started, upon control signal from the CPU 320, a staring operation is executed (S351), and thereafter, the lottery is executed (S352).

In the step 353 (S353), a normal game operation is executed for rendering the slot machine 100 to provide the player a normal game. In the normal game, the symbols on the reels 3L, 3C, 3R are rotated, and the combination of the symbols on the pay line L1 is determined whether the combination matches with the predetermined condition to start a bonus game operation (S354). With the condition is not established (No, in S354), the main operation is terminated, whereas with the condition is established (Yes, in S354), the bonus game operation is executed (S355).

In the bonus game operation (S355), a game with a dice described in the first to sixth embodiments is executed.

Meanwhile, the present invention may have applicability to a combined configuration of the first to seventh embodiment described above.

What is claimed is:

1. A gaming machine comprising:
a first numeric value selection device automatically selecting at least one first numeric value, in a predetermined range, for a player of the gaming machine, and having a first storage device storing the first numeric value;
a second numeric value selection device automatically selecting at least one second numeric value falling in the same range as that of the first numeric value and having a second storage device storing the second numeric value; and
a win and loss determination device making comparison between the first numeric value and the second numeric value for determining a wind and loss of a game to be executed by the gaming machine.

2. The gaming machine according to claim 1, wherein
the predetermined range, which is preliminary determined for the first numeric value, includes a natural number selectable by the first numeric value selection device,
the range selectable by the second numeric value selection device includes a natural number that is less than the first selected numeric value.

3. The gaming machine according to claim 1, wherein
the game, to be executed by the gaming machine, includes at least one stage, and the win and loss determination device determines a win and loss for each stage.

4. The gaming machine according to claim 2, further comprising:
a player-side dice-number re-determination device re-determining a whole of or a part of the first numeric value, determined by the first numeric value selection device, upon selection of the player.

5. The gaming machine according to claim 1, wherein
the win and loss determination device makes determination whether or not the first numeric value, selected by the first numeric value selection device, matches a predetermined combination whereby when the first numeric value matches the predetermined combination, a premium is paid out to the player.

6. The gaming machine according to claim 1, wherein
the game, to be executed by the gaming machine, includes a plurality of stages,
and further comprising:
a third value selection device operative to determine a third value based on which a value of a difficulty level is randomly determined for determining a difficulty level of each stage and at least one of the ranges, which the first and second numeric value selection devices can take, is determined depending on the value of the difficulty level;
wherein the first numeric value selection device allows the first numeric value, selected by the first numeric value selection device, to be stored in the first storage device associated with a number corresponding to the third value determined by the third value selection device;
wherein the second storage device allows the second numeric value, selected by the second numeric value selection device, to be stored in the second storage device associated with a number corresponding to the third value determined by the third value selection device, and
wherein the win and lose determination device is operative to determine a win and loss for each stage.

7. The gaming machine according to claim 6, wherein
the third value selection device is operative to determine the third value for the first numeric value selection device, while determining the third value for the second numeric value selection device, and determine the third value for the first numeric value selection device and the third value for the second numeric value selection device such that a difference or ratio between the third value for the first numeric value selection device and the third value for the second numeric value selection device takes a numeric value depending on the value of the difficulty level of the game executed in the gaming machine.

8. The gaming machine according to claim 6, wherein
the third value selection device that randomly determines the value of the difficulty level and selects the third value in the range of N-pieces to M-pieces depending on the value of the difficulty level,
the second numeric value selection device selects the second numeral value by the number of the third value determined the third value selection device,
the first numeric value selection device selects L-pieces of the first numeral value, and wherein wherein the N, M and L take natural numbers, respectively, under a relationship expressed as N<M≦L.

9. The gaming machine according to claim 6, wherein
a difficulty level display area is provided for notifying the number of remaining stages for the number of the second storage device.

10. The gaming machine according to claim 6, wherein
the second numeric value selection device selects O-pieces of the second numeric values; and
the third value selection device selects the third value in the range of P-pieces to Q-pieces; and further comprising:
the first numeral value selection device selects the first numeral value by the number of the third value determined by the third value selection device;
wherein the O, P and Q take natural numbers, respectively, under a relationship expressed as O≦P<Q.

11. The gaming machine according to claim 6, wherein
a difficulty level display area is provided for notifying the number of remaining stages for the number of the second storage device.

12. The gaming machine according to claim 6, wherein
determination of the difficulty level is controlled depending on the number of bets.

13. The gaming machine according to claim 1, wherein
the game, to be executed by the gaming machine, is configured to allow a Jackpot to be executed when a predetermined condition is satisfied,
and further comprising:
a bet value processor storing bet values forming the number of bets credited by the player at a start of the game;
a Jackpot startup condition storage device storing a bet number condition, forming a condition under which a lottery is executed for the Jackpot, in a manner to be re-writable; and
a game outcome processor operative to permit a game value to be paid out to the player depending on an outcome of the game while executing the lottery for the Jackpot when the number of bets, stored by the bet value processor, satisfies the bet number condition for executing the lottery for the Jackpot.

14. The gaming machine according to claim 13, wherein
the bet number condition lies in a range of the number of bets.

15. The gaming machine according to claim 13, further comprising:
an input device inputting the bet number condition stored in the Jackpot startup condition storage device.

16. The gaming machine according to claim 1, wherein
the game, to be executed by the gaming machine, has a plurality of stages;
and further comprising:
a bet value processor storing the number of bets paid out by the player, and
wherein the gaming machine determines a stage available to be played by the player from among the plurality of stages depending on the number of bets stored by the bet value processor.

17. The gaming machine according to claim 16, further comprising:
a Jackpot accumulation device, accumulating Jackpot values for storage, which determines an availability of a winning of a premium, associated with a Jackpot value, depending on the number of bets stored in the bet value processor.
